(19) United States
(12) Patent Application Publication
(10) Pub. No.: US 2018/0266938 A1
(43) Pub. Date: Sep. 20, 2018

(54) SYSTEM AND METHOD FOR PARTICLE CHARACTERIZATION

(71) Applicant: Symmetry Sensors, Inc., San Carlos, CA (US)

(72) Inventor: Vincent Y. Chow, San Carlos, CA (US)

(21) Appl. No.: 15/922,112

(22) Filed: Mar. 15, 2018

Related U.S. Application Data
(60) Provisional application No. 62/472,422, filed on Mar. 16, 2017.

(51) Int. Cl. G01N 15/14; G06K 9/62

(52) U.S. Cl. CPC G01N 15/1475; G01N 15/1429; G06K 9/6206; G01N 2015/1497; G01N 15/1459; G01N 2015/1479; G01N 15/1404

(57) ABSTRACT

A method and system for particle detection and characterization including a current confining pixel and a light source. The pair of light detectors may comprise a first light detector and a second light detector electrically coupled to one another. Further, the first and the second light detectors may be situated in parallel and may have inverse polarities. Further, the particle detector method and system can comprise a boundary vernier-line having a width separating the first and the second light detectors. It may comprise a signal processor for processing an output waveform generated by a particle as it flows unobstructed on or near the detector surface; wherein the output waveform is bipolar and a polarity of the output waveform may flip when the particle crosses the boundary vernier-line; and wherein the signal processor may analyze the output waveform to ascertain at least one property of the particle. Methods of using the same are also disclosed.

### CROSS-REFERENCE TO RELATED APPLICATIONS

This application claims the benefit of U.S. Provisional Application No. 62/472,422, filed 16 Mar. 2017, which is incorporated in its entirety by this reference.

### TECHNICAL FIELD

This invention relates generally to the particle characterization field, and more specifically to new and useful systems and methods for optical particle detection and characterization in the particle characterization field.

### BACKGROUND

There are many currently-known optical type-detectors and products generally designed to detect particles. The detection methods and systems used range from direct methods where the particles to be detected are directly imaged, to indirect methods where the presence and characterization of single or multiple particles is inferred from properties of the local environment that are affected by the presence of particles. Particle detectors and counters where the detector is in-line with and directly receiving light from a light source and the particles to be detected are located between the light source and the detector, such that the detector directly perceives the particles and the loss of light caused by the particles being present, are examples of a direct method of particle detection. There are also light scattering methods, as used in many particle counters and smoke detectors, where the detector is off-line from the light source and directly detects the presence light reflected or scattered off of the particles to be detected. Indirect detectors include, for example, ionization detectors that deduce or estimate the existence of particles based upon a change in electric current resulting from the ionization process that occurs when soot particles in smoke are present.

Existing schemes have several disadvantages. Indirect methods inherently provide an estimation, instead of a direct measurement. Direct methods often fail to detect the particles if particles are too small, and if the detection signal is amplified, the SNR is often insufficient to discern particle properties. Conventional direct photoelectric and light-scattering detection methods are often unable to see or detect the much smaller sized particles necessary to measure clean-room detection (e.g., for sensing particles as small as 0.1 micron in diameter) or air quality detection (e.g., particles as small as 50 nanometers in diameter).

Attempts to mitigate these deficiencies using conventional systems is expensive and cost-prohibitive, in particular for cost-sensitive industries and consumer products, such as in smoke detectors and air-quality monitors for home, work, and/or automobiles. Highly sensitive particle detectors are also typically large and bulky, making them unsuited for use in commercial applications in small and other types of consumer products such as mobile devices and smartphones. There are also significant problems with current methods and devices to be able to accurately detect particles and particle properties over electronic or optical noise that may be present and that can drown-out the electrical or optical signal of interest.

Thus, there is a need in the particle characterization field to create new and useful systems and methods for low-noise, low-power, high-sensitivity, high-dynamic-range optical detection and particle characterization. This invention provides such new and useful systems and methods.

### BRIEF DESCRIPTION OF THE FIGURES

FIG. 1 depicts a schematic illustration of an example embodiment of a system for particle detection and characterization;

FIG. 2 depicts a flow chart of an example embodiment of a method for particle detection and characterization;

FIGS. 3A and 3B depict example configurations of a portion of the system for particle detection and characterization;

FIG. 4 depicts a schematic illustration of an example configuration of a portion of the system for particle detection and characterization;

FIGS. 5A-5F depict example configurations of a portion of the system for particle detection and characterization;

FIG. 6 depicts a schematic illustration of an example of a portion of the system for particle detection and characterization;

FIG. 7 depicts a diagram illustration example outputs of an example portion of the system for particle detection and characterization;

FIG. 8 depicts an example configuration of a variation of the system for particle detection and characterization including an array of current confining pixels;

FIG. 9 depicts a specific example configuration of a portion of the system for particle detection and characterization;

FIG. 10 depicts an example of a portion of the system for particle detection and characterization;

FIG. 11 depicts a cutaway view of an example packaging configuration of an example of the system for particle detection and characterization;

FIG. 12 depicts an example configuration of processing circuitry of an example of the system for particle detection and characterization;

FIG. 13 depicts an example configuration of the system for particle detection and characterization;

FIG. 14 depicts an example configuration of the system for particle detection and characterization;

FIG. 15 depicts a portion of an example implementation of the method for particle detection and characterization;

FIG. 16 depicts a portion of an example implementation of the method for particle detection and characterization

FIG. 17 depicts a portion of an example implementation of the method for particle detection and characterization;

FIG. 18 depicts a portion of an example implementation of the method for particle detection and characterization;

FIG. 19 depicts a portion of an example implementation of the method for particle detection and characterization;

FIG. 20 depicts a portion of an example configuration of a portion of the system for particle detection and characterization; and

FIG. 21 depicts an example configuration of a portion of the system for particle detection and characterization including indirect direction.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

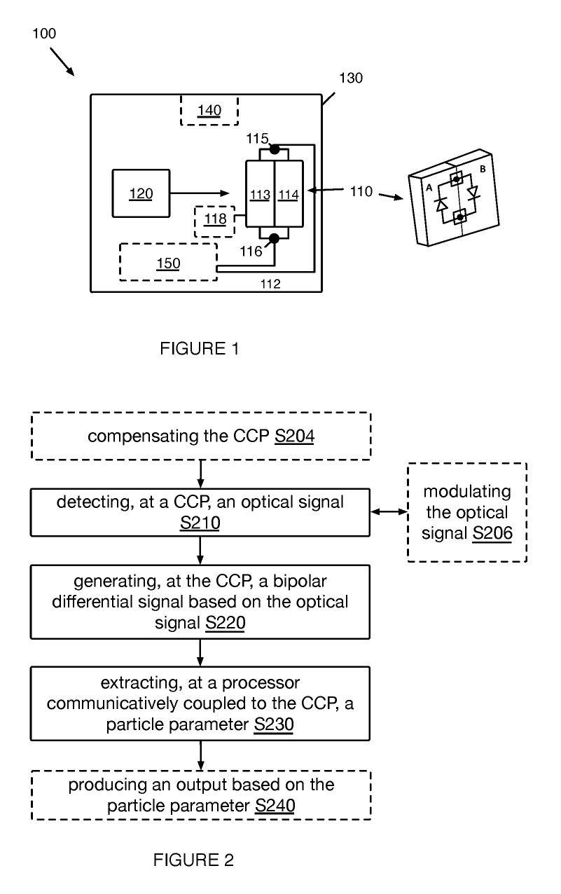

As shown in FIG. 1, an embodiment of the system 100 for particle characterization includes: a current confining pixel (CCP) 110, a light source 120, and a housing 130. The CCP 110 preferably includes a detector pair 112, the detector pair 112 including a first detector 113 and a second detector 114, coupled together in an inverse polarity configuration such that the CCP 110 defines a sense node 115 and a reference node 116 that together form a differential output across the pair of detectors 112. The CCP 110 can optionally include a biasing element 118. The system 100 can additionally or alternatively include an actuator 140, a processor 150, and any other suitable component to facilitate optical particle detection and characterization.

The system 100 functions to detect particles (e.g., airborne particles, fluid-borne particles, particles traversing a vacuum, etc.). The system 100 can also function to determine various particle parameters (e.g., particle properties, particle characteristics, etc.) such as: size, shape, refractive index, composition, size distribution, shape distribution, refractive index distribution, composition, per particle mass, collective particulate mass, and any other suitable particle properties. The system 100 can also function to produce an output in response to detected and/or characterized particle properties (e.g., a fire alarm in response to detected smoke particles, an air quality alarm in response to detected particulates above a threshold amount, a data log of local air quality, etc.). However, the system 100 can additionally or alternatively have any suitable function.

As shown in FIG. 2, an embodiment of the method 200 for particle detection and characterization includes: detecting, at a CCP, an optical signal S210; generating, at the CCP, a bipolar differential signal based on the optical signal S220; and extracting, at a processor communicatively coupled to the CCP, a particle parameter S230. The method 200 can optionally include: compensating the CCP S204; modulating the optical signal S206; and, producing an output based on the particle parameter S240.

The method 200 functions to utilize one or more CCPs, in conjunction with related components (e.g., a light source, a housing, etc.) for particle detection and/or characterization. The method 200 can also function to produce an output based on the results of detection and/or characterization (e.g., transmit an alarm, log a data point, etc.). The method 200 can also function to perform any one or more of the functions described above in relation to one or more variations of the system 100, and/or any other suitable system for particle detection and/or characterization, using a system substantially similar to one or more variations of the system 100 and/or a different system. However, the method 200 can additionally or alternatively have any other suitable function.

The system 100 and method 200 can be used in conjunction with, implemented at, and/or executed by various related systems, mechanisms, and/or devices which may be improved by air quality monitoring and/or particle characterization capabilities, such as one or more user devices, output mechanisms (e.g., outputs), input mechanisms (e.g., inputs), communication systems, additional sensors, a power supply, a location system, and any other suitable system, subsystem, and/or component.

Examples of a user device used in conjunction with variations of the system 100 (e.g., wherein one or more CCPs are embedded within a user device, removably coupled to a user device, an integrated component of the user device, etc.), method 200, and/or variations thereof include: a tablet, smartphone, mobile phone, laptop, watch (e.g., mechanical watch, network connected watch, etc.), wearable device (e.g., network connected glasses, network connected headgear, network connected eyewear, etc.), and/or any other suitable user device. The user device can include power storage (e.g., a battery), processing systems (e.g., CPU, GPU, memory, etc.), user outputs (e.g., display, speaker, vibration mechanism, etc.), user inputs (e.g., a keyboard, touchscreen, microphone, etc.), a location system (e.g., a GPS system), sensors (e.g., non-CCP sensors and other optical sensors, such as light sensors and cameras producing single-ended signals; orientation and/or position sensors, such as accelerometers, gyroscopes, and altimeters; audio sensors, such as microphones, etc.), data communication system (e.g., a WiFi module, BLE, cellular module, etc.), or any other suitable component.

Outputs can include: displays (e.g., LED display, OLED display, LCD, etc.), audio speakers, lights (e.g., LEDs), tactile outputs (e.g., a tixel system, vibratory motors, etc.), or any other suitable output.

Inputs can include: touchscreens (e.g., capacitive, resistive, etc.), a mouse, a keyboard, a motion sensor, a microphone, a biometric input, a camera, a joystick, a videogame controller, or any other suitable input or input mechanism.

Communication systems used in conjunction with the system 100, method 200, and/or variations thereof can include one or more radios, transmitters, transceivers, IR transceivers, telecommunication relays, optical fibers, electrical signal carrying wires, or any other suitable component. The communication system can be a long-range communication system, a short-range communication system, or any other suitable communication system. The communication system can facilitate wired and/or wireless communication. Examples of the communication system include: 802.11λ, Wi-Fi, Wi-Max, WLAN, NFC, RFID, Bluetooth, Bluetooth Low Energy, BLE long range, ZigBee, cellular telecommunications (e.g., 2G, 3G, 4G, LTE, etc.), radio (RF), microwave, IR, audio, optical, wired connection (e.g., USB), or any other suitable communication module or combination thereof.

Additional sensors (e.g., non-CCP-related sensors, sensors that transform a non-optical signal into an optical signal, etc.) used in conjunction with the system 100, method 200, and/or variations thereof can include: cameras (e.g., visual range, multispectral, hyperspectral, IR, stereoscopic, etc.), orientation sensors (e.g., accelerometers, gyroscopes, altimeters), acoustic sensors (e.g., microphones), optical sensors (e.g., photodiodes, etc.), temperature sensors, pressure sensors, flow sensors, vibration sensors, proximity sensors, chemical sensors, electromagnetic sensors, force sensors, or any other suitable type of sensor.

A power supply used in conjunction with the system 100, method 200, and/or variations thereof can include a wired connection to electrical mains power and/or an AC-to-DC converter having any suitable output voltage, a wireless connection (e.g., inductive charger, RFID charging, etc.) to such a power source, a battery or other electrostatic energy storage device (e.g., secondary or rechargeable battery, primary battery, a non-rechargeable battery, a supercapacitor, a capacitor, etc.), energy harvesting system (e.g., solar cells, piezoelectric harvesting systems, pyroelectrics, thermoelectrics, etc.), or any other suitable system. In some variations, the system 100 and/or variations thereof can be unpowered, passive components (e.g., operative in a photovoltaic mode, a passive mode, an uncompensated mode, etc.).

A location system used in conjunction with the system 100, method 200, and/or variations thereof can include a GPS unit, a GNSS unit, a triangulation unit that triangulates the device location (e.g., user device location) between mobile phone towers and public masts (e.g., assistive GPS), a Wi-Fi connection location unit, a WHOIS unit (e.g., performed on IP address or MAC address), a GSM/CDMA cell identifier, a self-reporting location information, or any other suitable location module. Variations of the method 200 can include mapping optical perception outputs (e.g., of one or more CCPs at a location, coupled to a user device, etc.) in relation to a geographic area or other physical space using one or more location systems as described above.

Portions of the method 200 can be performed in whole or in part by a native application on a user device, but can alternatively be performed by a server, by a browser application on a user device, or by any other suitable apparatus. The user device is preferably a mobile device associated with the user, including mobile phones, laptops, smartphones, tablets, or any other suitable mobile device. The user device is preferably connected to the server, wherein the connection is preferably a wireless connection, such as WiFi, a cellular network service, or any other suitable wireless connection, a near field connection, such as radiofrequency, Bluetooth, or any other suitable near field communication connection, or a wired connection, such as a LAN line. The user device can additionally or alternatively function as the server, such as in a distributed network system. The method can be performed by one or more servers, wherein the servers can be stateless, stateful, or have any other suitable configuration or property.

### 2. Benefits

Variants of the system and/or method can confer several advantages and/or benefits.

First, variants of the technology can enable sensitive detection of particles and extraction of particle parameters. For example, detection of a single particle is enabled by appropriately sized CCP detector pairs, separated by appropriately sized vernier lines and/or widths (e.g., sized of similar order to the single particle size). In another example, the system enables detection of submicron particles via perception of Mie scattering signatures at a CCP.

Second, variants of the technology can enable phase-sensitive detection to be utilized for detection and characterization of particles. For example, variants including an array of CCPs (e.g., a CCP array) can convert particle motion relative to the array into phase content of the output signal (e.g., a tone burst signal), wherein the phase content can be locked into via phase-sensitive-detection equipment and techniques to remove common mode noise. In another example, variants including light source modulation can inject phase content into the input signal that is retained in the differential output signal, and that can be similarly locked into to enable phase-sensitive detection and noise-reduction (e.g., to produce a noise-reduced differential signal output wherein common mode noise is substantially removed).

Third, variants of the technology can provide a balanced optical detection configuration (e.g., an optical balance beam) with inherent compensation of detected background signals. In such variants, a CCP can generate a differential signal output proportional to a difference between background signals detected at the detection surface(s) of the CCP and signals present above background that are incident more (or less) on one (or the other) of the two detectors of the pair of detectors of the CCP. Due to the reversed polarity configuration of the CCP, photocurrent or photovoltaically-produced voltage generated in one or the other detector by an input signal incident on both detectors is balanced by the opposing detector and confined within the loop formed by the detector pair, such that no voltage difference or signal current is detectable between the sense node and the reference node of the CCP. The ability and high-sensitivity of the detector pair in transforming a normally single-end signal into a differential signal enables particle characteristics to be determined upstream of the sense node (e.g., within the CCP loop via analog computation, encoding of the particle characteristics into the optical signature detected at the CCP detection surface) for simplified detection, classification, and other particle detection operations. For example, in particle detection applications, including events wherein particles are simultaneously passing over the detector pair and scattering light from the light source, the frequency content of such signals can reveal particle attributes (e.g., two smooth surface solid light-blocking particles, versus one solid light-blocking and one refractive, will reveal different coincident signal signatures representative of the relative composition of the particle pairs). In other examples, probe light intensity can be increased to improve the signal-to-noise ratio of the output signal without the drawbacks of increased intensity in conventional systems (e.g., saturation, glow illumination, etc.).

Fourth, variants of the technology can be unhindered by strong incident illumination, due to the inherent balanced configuration of the CCP. Thus, SNR performance gains can be achieved by utilizing the brightest (e.g., most intense) probe light intensity permissible (e.g., based on available light sources, based on thermal dissipation limitations, etc.). For every doubling of the light intensity, SNR can increase by a factor of root 2 in examples of the technology.

Fifth, variants of the technology can enable characterization of air pollution. Air pollution can be characterized in both indoor and outdoor environments. Characterization can be performed in a steady or unsteady manner (e.g., time resolved characterization, time integrated, etc.). Characterization of air pollution can include smoke detection, PM2.5 level measurement, submicron particle detection and characterization, and the like. However, characterization of air pollution can additionally or alternatively include determining any suitable characteristics of airborne impurities or air composition.

Sixth, variants of the technology can enable integrated threshold-based triggering of behaviors in response to detected air quality metrics. Triggering can be based on pattern matching between an input signal and a known, selected, and/or predetermined reference signal. The pattern matching can be passive (e.g., wherein the CCP is compensated by structural asymmetries such as relative detector element sizes between the first and second detector, wherein the CCP is uncompensated, etc.) or active (e.g., wherein the CCP is actively compensated by an electrical bias, an optical bias, etc.). Pattern matching can be performed as a single-bit read, wherein the output of the CCP(s) of the detector is a single bit defining whether a match was obtained (e.g., a zero) or not (e.g., any value other than zero, another ternary logic value, etc.).

Seventh, variants of the technology can be packaged in a form factor that enables mobile device integration. For example, variants of the system can be integrated into a surface mount device (SMD) that can be integrated into a mobile phone proximal an externally-facing orifice (e.g., a microphone port, a speaker port, etc.) exposed to airflow from a user's surroundings.

Eighth, variants of the technology can enable division of signal processing between hardware and software. This flexibility is offered by the technology because, for example, a majority of the signal detection and characterization can be performed in the analog domain (e.g., analog optoelectronic domain) by filtering and pulling out relevant particle signals away from background signal and noise (e.g., electronic noise). Similarly, variants of the technology can include analog and digital circuitry (e.g., designed directly into a silicon chip) to move any suitable portion of a processing sequence into a fixed circuitry implementation (e.g., a state machine) to substantially mitigate a computing resource burden on a supportive portion of the processor (e.g., a microprocessor, a computer, a microcomputer, etc.). This can, for example, prolong battery life (e.g., in a portable smoke detector, in a mobile device with air quality detection capability, etc.).

However, variants of the system and/or method can otherwise confer any suitable advantages and/or benefits.

### 3. System

As shown in FIG. 1, an embodiment of the system 100 for particle characterization includes: a current confining pixel (CCP) 110, a light source 120, and a housing 130. The system 100 can additionally or alternatively include an actuator 140, a processor 150, and any other suitable component to facilitate optical particle detection and characterization.

### 3.1 Current Confining Pixel

As shown in FIG. 1, the current confining pixel (CCP) 110 preferably includes a detector pair 112, the detector pair 112 including a first detector 113 and a second detector 114, coupled together in an inverse polarity configuration such that the CCP 110 defines a sense node 115 and a reference node 116 that together form a differential output across the pair of detectors 112. The current confining pixel (CCP) 110 functions to contain current (e.g., actual current, virtual current, displacement current, charge flow, etc.) resulting from simultaneous (e.g., substantially simultaneous, contemporaneous, simultaneous within the time constant associated with the parasitic capacitance and/or inductance of the components, etc.) detection of an identical (e.g., substantially identical, equal in magnitude, equal in phase, equal within a detectability threshold range, equal within a quantum fluctuation threshold range, equal within a shot-noise limited range, etc.) signal at both of the pair of detectors 112 without surfacing the current (e.g., as a detectable voltage difference, as a detectable signal current, etc.) at the differential output (e.g., across the sense node and the reference node of the CCP). In instances wherein the signal received at the pair of detectors 112 is not identical as described, the difference between the signal (or portion of the signal) received at the first detector 113 and the second detector 114 is surfaced (e.g., as a detectable voltage difference, as a detectable signal current, etc.) at the differential output to a degree proportional to the difference (e.g., having a magnitude proportional to the difference in input signal magnitude between the first and second detector). Accordingly, the CCP 110 is preferably resistant (e.g., substantially impervious, substantially mitigating, etc.) to saturation (e.g., is insaturable) by an input signal (e.g., of any magnitude less than the survivability threshold of the materials making up the CCP, less than a thermal dissipation threshold, etc.) in instances wherein the magnitude of the portion(s) of the signal detected at each of the first detector 113 and the second detector 114 are substantially identical, due to balancing of the optical inputs across the inverted detector pair. However, in variations, the CCP 110 can additionally or alternatively be configured to be saturable (e.g., at a threshold confined current magnitude). In some variations, the system 100 can include a plurality of CCPs arranged in a CCP array 111, as described in further detail below.

The CCP 110 and components thereof are preferably fabricated via a semiconductor process in a monolithic configuration, but can additionally or alternatively be fabricated such that individual components are packaged separately and connected after fabrication (e.g., in individual surface mount component packages). The base material of the CCP is preferably silicon (e.g., in applications suitable for detecting optical signals in the visible range), including doped and undoped silicon in any suitable combination, but can additionally or alternatively include any suitable semiconductor material such as: carbon (e.g., crystalline diamond, graphene, carbon nanotubes, etc.), germanium (Ge), gray tin, silicon compounds (e.g., SiC in 3C, 4H, 6H, and any other suitable forms), group VI semiconductors (e.g., sulfur/S₈, Se, Te, etc.), group III-V semiconductors (e.g., cubic BN, hexagonal BN, BN nanotubes, BP, Bas, B₁₂As₂, AlN, AlP, AlAs, AlSb, GaN, GaP, GaAs, GaSb, InN, InP, InAs, InSb, Type I, II, III super-lattice miniband structures, Type II strained layer super-lattice, etc.), group II-VI semiconductors (e.g., CdSe, CdS, CdTe, ZnO, ZnSe, ZnS, ZnTe, etc.), group I-VII semiconductors (e.g., CuCl), group I-VI semiconductors (e.g., Cu₂S), group IV-VI semiconductors (e.g., PbSe, PbS, PbTe, SnS, SnS₂, SnTe, PbSnTe, Tl₂SnTe₅, Tl₂GeTes, etc.), group V-VI semiconductors (e.g., layered Bi₂Te₃), group II-V semiconductors (e.g., Cd₃P₂, Cd₃As₂, Cd₃Sb₂, Zn₃P₂, Zn₃AS₂, Zn₃Sb₂, etc.), oxide semiconductors (e.g., Tio₂ in anatase, rutile, and/or brookite phases, Cu₂O, CuO, UO₂, UO₃, Bi₂O₃, SnO₂, BaTiO₃, SrTiO₃, LiNbO₃, La₂CuO₄, etc.), layered semiconductors (e.g., PbI₂, MoS₂, GaSe, SnS, Bi₂S₃, etc.), diluted magnetic semiconductors (e.g., GaMnAs, InMnAs, CdMnTe, PbMnTe, etc.) magnetic semiconductors (e.g., FeO, NiO, EuO, EuS, CrBr₃, etc.), and any other suitable semiconductor materials (e.g., CuInSe₂, AgGaS₂, ZnSiP₂, As₂S₃, As₄S₄, PtSi, BiI₃, HgI₂, TlBr, Ag₂S, FeS₂, Cu₂ZnSnS₄, Cu₂SnS₃, etc.) in any suitable phase. The CCP and/or components thereof can additionally or alternatively be made of materials including microbolometers (e.g., amorphous silicon, vanadium oxide, Ti, YBaCuO, GeSiO, poly SiGe, BiLaSrMnO, protein-based cytochrome C, bovine serum albumin, etc.), pyroelectric materials (e.g., gallium nitride, caesium nitrate such as CsNO₃, polyvinyl fluorides, derivatives of phenylpyridine, cobalt phthalocyanine, lithium tantalate such as LiTaO₃, etc), piezoelectric materials (e.g., natural crystals, natural biological materials, synthetic crystals, Lead zirconate titanate and similar piezoceramics, PVDF and similar polymers, PNTs and similar organic nanostructures, III-V and II-VI semiconductors, etc.), and any other suitable materials.

In a specific example, the CCP 110 can be fabricated on a silicon chip using a CMOS process. The chip on which the CCP 110 is fabricated can additionally or alternatively be patterned with signal processing circuitry downstream (e.g., in signal propagation coordinates) of the output nodes (e.g., sense node, reference node, etc.) of the CCP, passive components as patterned features (e.g., capacitive features; inductive features; resistive features; features having any suitable specified and/or parasitic combination of capacitance, inductance, and/or resistance, etc.), sampling nodes (e.g., locations wherein signals can be tapped and/or read out), and any other suitable patterned elements. Fabrication preferably includes lithography (e.g., photolithography), but can additionally or alternatively include plasma etch, ion milling, chemical etch, and/or fabrication by any suitable semiconductor manufacturing methodology and/or technique.

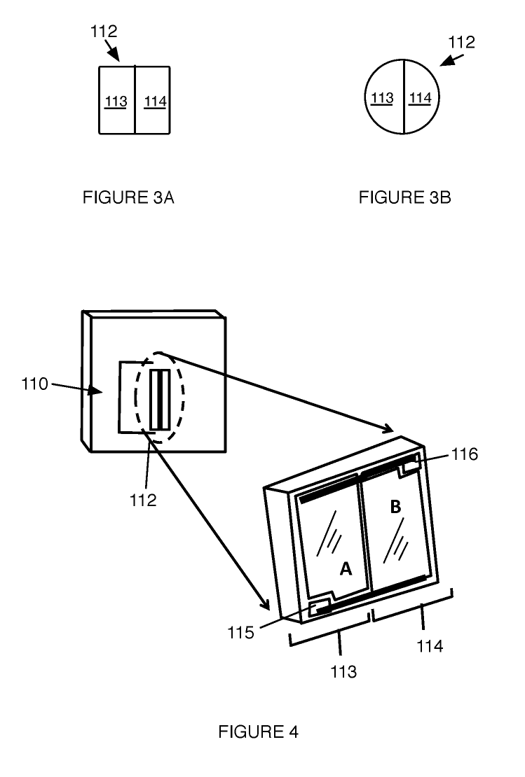

The detector pair 112 functions to confine the current within the CCP upon detection of a symmetric input signal (e.g., equal in magnitude between each detector) and to generate a differential output (e.g., across the sense and reference nodes) upon detection of an asymmetric input signal. The detector pair 112 can also function to provide the detection surface of the CCP 110 (e.g., the surface at which electromagnetic radiation input signals are transduced into electrical signals via generation of electron-hole pairs in the semiconductor material). The detector pair 112 can have any suitable size (e.g., the detection surface can have any suitable area, the area can be sized according to the application, such as based on the relative magnitude of particles to be detected, etc.), based on the patterning process and/or other fabrication method (e.g., a micron process, a 10 nm process, a macro process, etc.). The detector pair 112 can define any suitable shape (e.g., surface area shape). For example, the detector pair 112 can define a rectilinear outline in a manner similar to a unitary pixel, as shown in FIG. 3A. In another example, the detector pair 112 can define a circular outline, wherein the first and second detector each define half of a bisected circle, as shown in FIG. 3B. However, the detector pair can additionally or alternatively define any suitable shape and/or surface area.

In a specific example, the detector pair 112 includes two P-I-N photodetectors (e.g., the first detector 113 and second detector 114, a PIN photodiode, etc.), which can be represented by the letters “A” and “B,” respectively, as shown in FIG. 4. The photodetectors in this example can define near-functionally identical active areas such that they are abutted along one edge and electrically isolated by a thin boundary region (e.g., a vernier line). The width of the boundary region, in this and related examples, can be fabricated to be as small as possible (e.g., within the limit of the fabrication process); alternatively, however, the width of the boundary region can be selected and defined at a specified width greater than a minimum width afforded by the fabrication process (e.g., based on the detector application). In this example and related examples, the two P-I-N photodetectors may be electrically interconnected with electrically conductive material (e.g., layers of a semiconductor, metallic traces, embedded vias, etc.) in a parallel inverse manner to achieve the inverse polarity connectivity configuration. In particular, in this example, the electrically conductive material connects the N side of photodetector A to the P side of photodetector B through contact holes in each photodetector, and also connects to a contact pad. Similarly, in this example, conductive material connects the P side of photoconnector A to the N side of photoconnector B through contact holes and connects to contact pad. The aforementioned layout is an example configuration of the stable two-node (e.g., sense node and reference node) differential aspect of the CCP 110.

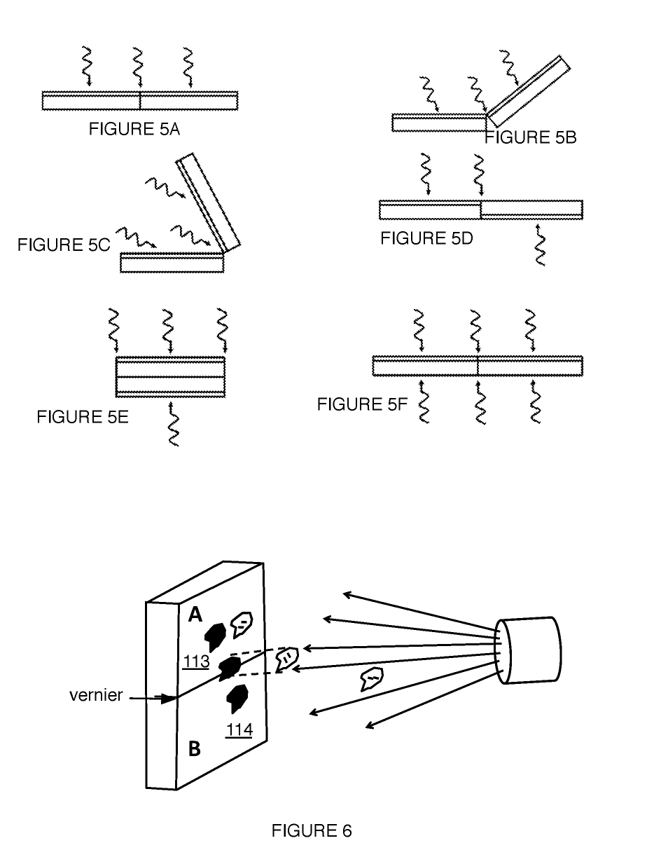

The pair of detectors 112 of the CCP 110 can be configured in various relative arrangements. For example, the first detector 113 and second detector 114 can be coplanar, wherein the active surface (e.g., detection surface, photosensitive surface, phonon-sensitive surface, etc.) of each detector is at the same side of the coplanar plane (e.g., as shown in FIGS. 5A-5C, 5F) or wherein the active surfaces of each detector are on opposing sides of the plane (e.g., as shown in FIG. 5D). In related examples, the surfaces of the first and second detectors can define an angle (e.g., occupy intersecting planes, as in FIGS. 5B and 5C), which can be a right angle, an acute angle (e.g., as shown in FIG. 5C), and/or an obtuse angle (e.g., as shown in FIG. 5B). In still further examples, the first detector 113 and second detector 114 can be arranged back-to-back, as shown in FIG. 5E, such that the active surface(s) are arranged in opposing directions. In any of the aforementioned examples or similar examples, the first and second detectors need not be directly adjacent, and can be separated by any suitable distance and maintain the relative angular arrangement described. In further example configurations, the first detector 113 and second detector 114 can be entirely separate and modular, and interconnected via the inverse polarity configuration, and maintain the current confining differential output capacity.

In some variations, the first detector 113 and second detector 114 of the detector pair 112 can be separated by a vernier-line, as shown in FIG. 6. In some examples, the vernier-line can define a fixed width (e.g., an inactive portion of the CIP surface between the first and second detectors), whereas in other examples, the vernier-line can define an infinitesimal width (e.g., the virtual crossover line between the first detector and a directly adjacent second detector of the detector pair). In examples wherein the vernier-line defines a fixed width, the width can be determined based on desired perception targets (e.g., a width can be selected that corresponds to an average particle size in a particle detector application of the CCP), and/or be determined using any other suitable basis.

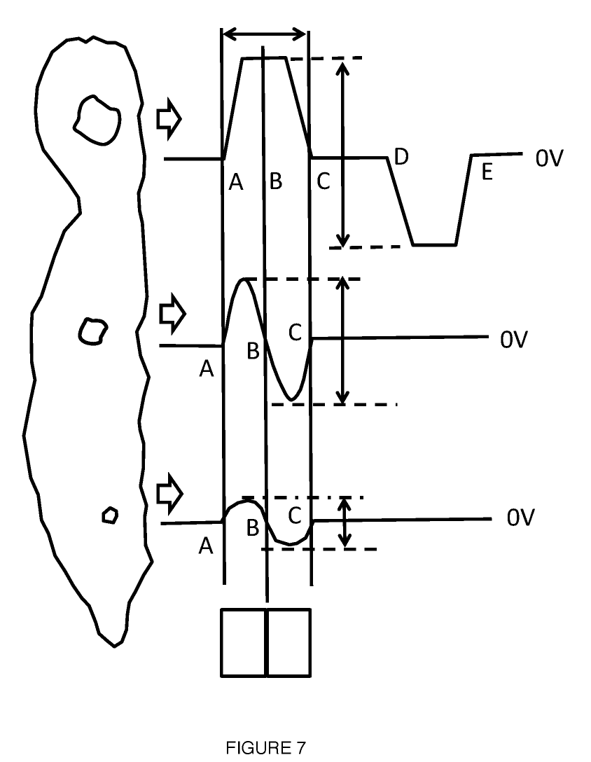

As shown in FIG. 7, in examples, the vernier line width can function to generate various differential signal outputs depending on the particle size being detected. The widths of the two detectors (e.g., first detector 113, second detector 114) are represented in FIG. 7 by the distance A:B for one detector and B:C for the parallel inverse second detector. Three example particle sizes including large (e.g., Type I), medium (e.g., Type II) and small (e.g., Type III) particle diameters are shown flowing within a plume. The respective detected signal signatures are depicted alongside. With a large particle diameter (Type I) spanning A:C and larger, the resulting signal waveform (e.g., differential output signal) can include a signature expressing flat-top saturation levels at both Vmax and Vmin, in addition to a zero-volt span having a duration C:D (e.g., wherein the zero-volt span can increase in duration along with increasing particle diameter). The ratio of this C:D span to the widths (A:B, B:C) of the detectors can, for example, indicate the size of single large particles (e.g., a particle parameter of single large particles). The negative waveform (e.g., from D:E in FIG. 7) can be generated for all particle signal waveforms due to the inherent zero-crossing property of the CCP, as discussed above. The zero-cross symmetry can, in examples, enable high discrimination of signals generated by detected particles away from that of random electrical noise present at the sense node (e.g., wherein electrical noise riding atop the sense node signal is not inherently of a bipolar symmetric nature). For medium particle size diameters (Type II) near the A:B span, the signal signature can, in examples, lack the flat-top saturation and the zero-volt span C:D; however, for some medium particle size diameters, the flat-top saturation and/or the zero-volt span can be maintained. For small particle size diameters (Type III) less than a distance A:B and, in examples, as small as detectable in the limit of the vernier-line width, the signal signature can, in examples, include a unique symmetric wave that maintains a zero-cross property (e.g., always maintains, substantially always maintains, often maintains, etc.).

Various configurations of the detector pair 112 (e.g., as shown in FIGS. 5A-5F) can afford different performance attributes (e.g., detection volume, signal bandwidth, sensitivity, etc.) to match unique requirements for various applications (e.g., particle detection). The active light sensing area (e.g., detection surface) of each detector faces toward the incident probe light beam shown by light rays for left, vernier-line center, and right of the detector pair 112. The substrate or backside of the detector pair 112 can be non-light-sensitive, less sensitive (e.g., devoid of any sensitivity enhancing coatings or materials), or equivalently sensitive as the front side. In an alternative configuration, the obtuse angle can provide a greater solid angle of view of the region within the V-confined apex, and can be matched to narrow frontal probe light beams (e.g., from a light source including a collimated light emitter such as a laser). In an alternative configuration, an acute angle can further increase the solid angle of view and SNR as the probe light beam is further narrowed and concentrated (e.g., by using any suitable laser). In further alternative configurations, combining frontal and rear light beam sources can facilitate compensation or bias of one or the other detector of the detector pair (e.g., to balance an uncontrolled input signal, to match an asymmetric input signal, etc.). For example, a configuration that is also planar but inverts one detector to sense an isolated light source while the front detector views the incident light of the light source (e.g., and/or scattering signals from particles) can be used. Such configurations can enable suppression of background illumination to maintain a constant zero-null signal state at the detector-pair sense node (e.g., across the sense node and reference node). In this example configuration, the probe scan light now may be steady, modulated and/or pulsed but the sense node zero-null state can be maintained (e.g., in the absence of particle signals). Since the detector pair 112 can be considered substantially analogously to a balance beam sensitive to area-integrated illumination intensity in lieu of mass weights, the light signal can be sensed at the top or bottom of each detector (e.g., at the detection surface) to produce substantially identical responses at the sense node 115. Similarly, each side of the CCP can include multiple detector units connected together wherein each can sense a separate probe light signal, but the net differential output can be detected at a single sense node. In an alternative configuration, the detector-pair 112 can be arranged in a sandwich layout, wherein the folded edges are at one side and the vertex is at the opposite side, while sensing both frontal and rear input signals. This example arrangement can permit high-density packing and tiling blocks of detector pairs 112 (e.g., of CCPs 110 in a CCP array 111), with background light suppression, to form any suitable tiled geometric layouts.

In variations, one or more surfaces of the detector pair 112 can include morphological features (e.g., to enhance performance, to guide airflow, to enhance detection sensitivity, etc.). For example, in a particle detection application, the surface can define one or more shallow V-grooves etched into the surface to increase near-field contact probability of nanometer particles. The V-channels can act like a guide trench (e.g., flow guide) that can confine the particle direction of motion to follow the groove of the trench path and thereby increase detection probability (e.g., by increasing proximity to the detection surface and therefore increasing the sharpness of the scattering shadow signature, by increasing residence time of the particle in the vicinity of the surface, etc.). In a related example, one or more electrodes can be coupled to the V-groove surfaces and, during operation, excited by voltage waveforms (e.g., AC waveforms, DC waveforms, a superposition of AC and DC waveforms, etc.) to attract or repel particles. However, the surfaces of each detector of the detector pair of each CCP can additionally or alternatively include any suitable morphological features.

The CCP 110 can optionally include a biasing element 118. The biasing element 118 functions to bias one or more of the detectors 113, 114 of the CCP (e.g., relative to one another, relative to a baseline to produce a symmetric offset, etc.). The biasing element 118 can include an electrical bias (e.g., a voltage source, a current source) placed in series within the CCP loop, an optical bias (e.g., a portion of the light source, a distinct light source, etc.), a physical bias (e.g., wherein the CCP is constructed with an asymmetric area ratio between the first and second detector, wherein the CCP is constructed with dissipative or resistive elements in parallel with the first or second detector, etc.), and any other suitable bias.

The biasing element 118 can be constructed as a part of the fabrication process and thereby be static in bias provision (e.g., as in the case of a physical bias), or can be dynamically applicable (e.g., as in the case of an optical bias, a voltage bias, any other active bias, etc.). Application of bias by the biasing element 118 can be referred to as compensation elsewhere in this document; however, in variations, the system 100 and uses thereof in accordance with the method 200 or other techniques can include both compensating and biasing simultaneously or in lieu of one another.

In a specific example, the biasing element 118 includes an optical emitter arranged to illuminate a back side (e.g., a non-detection surface) of the CCP in an adjustable, asymmetric, and/or symmetric manner, such that the differential output of the CCP can be set to zero in the absence of an input signal. In a related example, the biasing element 118 includes an optical emitter arranged to illuminate the first detector only, without illuminating the second detector, at a front side (e.g., detection surface) of the first detector. In various applications of these and other related examples, the intensity of the output of the optical emitter can be adjusted to set the differential output of the CCP to any suitable value (e.g., zero, a predetermined threshold value, etc.). In another related example, the biasing element 118 includes an optical emitter arranged to symmetrically illuminate a backside of the CCP (e.g., both the first and second detectors) to generate an offset bias. However, the biasing element 118 can additionally or alternatively provide any suitable bias in any suitable manner.

In variations, the biasing element 118 can include a feedback control loop to maintain the differential output value at a set point. This feedback control loop is preferably a proportional-differential-integral (PID) controller, but an additionally or alternatively implement any suitable control paradigm to maintain the differential output value at a set point.

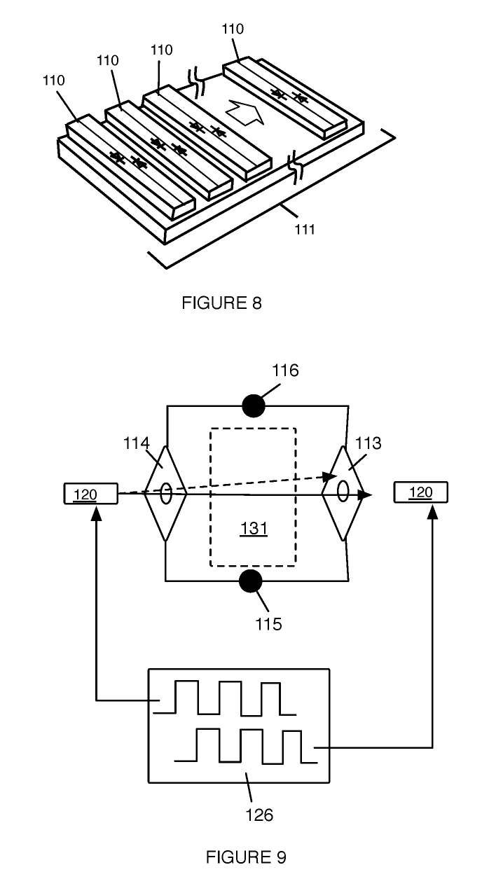

Variants of the system 100 include arrangements of a plurality of CCPs 110 into a CCP array 111. As shown in FIG. 8, the CCP array 111 can be a linear array. In alternative variations, the CCP array 111 can be a two-dimensional array (e.g., a rectilinear array, a circular array, etc.), a three-dimensional array (e.g., patterned on the surface of any suitable 3D shape), and/or have any other suitable shape or arrangement. The CCP array 111 can be fabricated (e.g., etched, patterned, etc.) into a single monolithic chip, formed from a plurality of individually fabricated CCP units, and any suitable combination of the aforementioned (e.g., formed from a plurality of multi-CCP arrays fabricated in a single chip).

In variations, CCP arrays can be configured for flow property determination. In one such example configuration, two CCPs in a CCP array can be arranged such that the first and second CCP are positioned at a predetermined offset adjacent to a sampling volume. During operation, particles traversing the sampling volume can generate particle detection events (e.g., bipolar differential output signals) at the first and second CCPs in a sequential manner. Comparison of the first and second signals associated with the particle detection events (e.g., bipolar differential output signals) can generate a particle parameter associated with the particle laden flow (e.g., flow rate, particle composition within the flow, time period of particle transport, etc.). In cases wherein a plurality of particles are transported through the sampling volume, individual particle signatures can be extracted from the first and second particle detection event signals based on a comparison between the successive signatures (e.g., based on portions of the respective signals which are characteristic of the individual particle such as rise time, effective period, waveform shape, etc.). This example configuration enables the CCP array to function as a flow sensor, flow monitor, flow rate sensor, particle flow rate detector, and any other suitable function related to flow characteristic monitoring.

In another example configuration, as shown in FIG. 13, a series of CCPS can be cascaded to form a linear or variable pitch CCP array. The CCP array can be affixed onto a SMD substrate, or otherwise suitably mounted. Such a configuration can enable tone burst detection. In a specific example of tone burst detection, the linear CCP array can include a number (e.g., twenty) of detector blocks (e.g., CCPs) spaced at a predetermined offset. The offset in this example functions to produce maximum tone response matched to a specific particle size, wherein the particle size is of the same order as the offset (e.g., in an analogous manner to an electronic bandpass filter). The linear CCP array can, during operation, output the sum of the number of signals (e.g., twenty signals) at the output nodes (e.g., sense node and reference node). The output nodes can, in examples, be wired and/or packaged as SMD outputs. In this example, the number of particle detection blocks can be designed as discrete units, but in related examples the number of CCPs in the array can be fully integrated as one array on a single silicon-chip along with support electronics. In operation as a particle detector, as a particle grazes along the surface of the cascaded detection array, a zero-cross bipolar pulse is output each time the particle traverses a CCP of the CCP array. The cycle period of pulses can be substantially constant due to the short span in travel, or the cycle period can be variable (e.g., due to flow dynamics). The series of sequential zero-cross pulse signals forms a tone burst signal with increased duration (e.g., due to the transit time of the particle over the array) that can enable sensing by phase-lock or bandpass filtering techniques. This configuration and operation can also enable time-division-integration (TDI) techniques (e.g., to be used to achieve maximum detection sensitivity for submicron particles). In further examples, multiple CCP arrays, each set with a different offset, can be cascaded to provide particle distribution and variation data as a function of time. Accordingly, a variable pitch CCP array can be included to add statistical process (SPC) control for special particle flow control applications.

### 3.2 Light Source

The light source 120 functions to generate light and to illuminate at least a portion of the detection surface of a detector (e.g., detector 113, detector 114) of the CCP 110. The light source 120 can include a light emitter 122, an optic 124, a modulator 126, and any other suitable component related to light generation and transmission. In some variations, the light source 120 can be an external light source reflected off of a scene to form an image; for example, in an area illuminated by the Sun or interior lighting, the light source can be the scattering objects (e.g., objects in the scene, which in such cases can act as light emitters 122).

The light source 120 can include a lamp, a light emitting diode (LED), a laser, a heated filament, a fluorescent substance, and any other suitable source of light. The light source 120 can include a single light emitter or a plurality of light emitters. In variations including a plurality of light emitters, the light emitters can have a one-to-one correspondence with CCPs (e.g., of a CCP array), a one-to-one correspondence with detectors of a single CCP (e.g., a first light emitter associated with a first detector 113, and a second light emitter associated with a second detector 114 of a CCP 110), a many-to-one correspondence (e.g., a plurality of light emitters that illuminate a single CCP or detector), a one-to-many correspondence (e.g., a single light emitter that illuminates a plurality of CCPs or detectors), and any other suitable correspondence.

The light source 120 can be used to facilitate input signal collection (e.g., by provision of a background light that can be modulated by the presence of particles, particle scattering, etc.), as well as to provide compensation (e.g., acting as all or part of the biasing element 118 as described above).

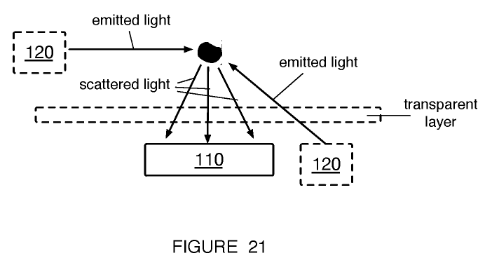

The light source 120 can be arranged in various relative orientations with respect to the CCP 110. The light source 120 can be configured in a direct detection orientation, wherein the detection surface(s) of the CCP 110 are separated from the light source 120 along an optical axis of the emitted light from the light source 120 (e.g., wherein the light source is situated along a normal and/or perpendicular direction away from the detection surface). The light source 120 can additionally or alternatively be configured in an indirect detection orientation, wherein the optical axis and/or axes of the light emitted from the light source 120 is oblique to (e.g., perpendicular to, at an angle relative to, etc.) the normal direction of the detection surface of the CCP 110. Example indirect detection configurations of the light source relative to the CCP are shown in FIG. 21. However, the light source 120 can additionally or alternatively be arranged relative to the CCP 110 in any suitable manner and/or orientation.

The light source 120 can include an optic 124, which functions to image the light source 120 (e.g., the light emitter 122 of the light source) onto the CCP 110. The optic 124 can include a lens, a set of lenses, a telescope, a spatial filter, an aperture, a prism, a phase plate, and any other suitable optical element configured to passively transform light from the light source (e.g., focus, diffuse, expand, contract, etc.). In a specific example, the optic 124 includes a simple lens defining a focal length, wherein the optic is arranged to produce an image of a scene that fills a circular CCP (e.g., separated from the CCP surface by a distance selected to fill the detection surface of the CCP with the image, based on the focal length of the lens). In another example, the optic 124 includes a mirror arranged to direct the output of a light emitter 122 (e.g., a laser) to the detection surface of the CCP. However, the optic 124 can include any other suitable optical elements otherwise suitably arranged.

The modulator 126 functions to modulate the light from the light emitter 122. Modulating the light from the light emitter can include injecting phase content of various types, such as: cycling the light emitter between “on” and “off”, modulating the intensity at a specific frequency (e.g., 1 GHz, any suitable frequency, etc.), modulating the angle of incidence at a specific frequency (e.g., 50 MHz, any suitable frequency, etc.), and/or otherwise injecting phase content into the input signal by way of modulating the light from the light emitter 122. The modulator 126 can include an acousto-optic modulator (AOM), an electro optic modulator (EOM), a piezoelectric modulator (e.g., to vibrate the light emitter), a wave generator (e.g., to duty-cycle the light source via a square wave driver or other suitable waveform), and any other suitable type of modulator.

In a specific example of the system 100, as shown in FIG. 9, including a modulator, a first and second light source, and a physically-separated first and second detector of the CCP, the modulator cycles two opposing light sources in mutually-exclusive duty cycles such that one or the other of the light sources is continuously on (e.g., emitting light), and only one of the two light sources is on at any given time. The detector surfaces of the opposing detectors each define an orifice through which the light emitted by the light source passes without illuminating the detector in the absence of a scattering element in the sampling volume, as shown in FIG. 9. In some applications of this example configuration, descending particles can be detected in accordance with the low-noise, high-sensitivity methods described herein in relation to usage of the CCP while reducing stray light (e.g., common mode light) incident on each of the two detector surfaces. In this example, the modulator preferably controls the first and second light sources between a first mode and a second mode, wherein in the first mode the first light source is in the on state and the second light source is in the off state and in the second mode the first light source is in the off state and the second light source is in the on state (e.g., the two light sources can be driven by a pair of opposite-duty-cycle square waves). The modulator can control the two light sources between the first and second mode at various frequencies, such as a frequency corresponding to the inverse of a characteristic time of particle residence in the sampling volume, a frequency above the Nyquist limit for particle detection based on the transit time and/or flow rate, and any other suitable frequency.

In some variations, the system 100 can include one or multiple light sources aimed at high and shallow incident angles at the detection surface of the CCP. Each light source can further be single-element or dual-element types (e.g., depending on desired zero-null precision, desired differential output signal precision relative to a set point, etc.). The configuration of this variation can provide enhanced signature detection capabilities by creating long or stretched shadows on the detector surface. The resulting differential output signal from the CCP on which elongated shadows are present can be compared ratiometrically to differential output signals produced by incident light at a higher angle of incidence. One advantage of this multiple light ratio can include the generation of a detectable signature that improves both detection threshold and signature type characterization (e.g., particle detection limit thresholds and particle type characterization). For example, a particle having an eccentric aspect ratio (e.g., large aspect ratio) can result in a ratiometric signature substantially different from a similarly-composed particle having an aspect ratio close to one (e.g., equal to one, approximately one, approximately between one and five, etc.).

In relation to variations including multiple light sources, the high-angle and low-angle incident light sources described above can further be of tunable multi-color LED or VCSELs that operate in at least two wavelengths. Such capability can function to provide increased characterization sensitivity. Increased characterization sensitivity can include greater signature differentiation between particle properties such as size, shape and material composition (e.g., usable, for example, to distinguish particles caused by combustion such as soot particles from non-combustion-related particles such as dust, steam, etc.).

In some variations, the light source 120 can directly illuminate the CCP (e.g., the detection surfaces of the detectors of the CCP). In alternative variations, the light source 120 can indirectly illuminate the CCP (e.g., via scattering processes, optical signal routing, etc.), wherein the CCP is not illuminated unless the output of the light source is perturbed (e.g., by a particle).

In a specific example of indirect detection, as shown in FIG. 21, the output rays (e.g., emitted light) of the light source are beamed into a sampling volume where a particle or particles entering this zone scatter the light output by the light source (e.g., via Mie scattering). The scattered light is detected by a CCP arranged oblique (e.g., orthogonal, at any suitable indirect angle, etc.) to the beam propagation direction (e.g., including imaging of the scattered light by a lens onto the detection surfaces of the CCP). In this example, a transparent window can be arranged between the sampling volume and the CCP, to enable isolation of the CCP from the sampling volume and/or the external environment (e.g., which can include the sampling volume). This example configuration can enable a high solid-angle detection volume to be maintained (e.g., to maximize the scattering SNR) and background light signals (e.g., from glow and/or stray reflections of the light source) to be substantially rejected, as afforded by various CCP configurations.

### 3.3 Housing

The housing 130 functions to retain components of the accept fluid (e.g., air) from the environment, wherein the fluid can be laden with particles, for detection by the CCP 110 in conjunction with the light source 120. The housing 130 can also function to define a package size of variations of the system 100 (e.g., a DIP package, a SMC package, an SMD package, etc.). The housing 130 preferably defines the sampling volume 131; however, in variations, the sampling volume 131 can be otherwise suitably defined by any other suitable component or components. The housing 130 can include one or more orifices 132, flow guides 134, and any other suitable components related to housing and/or retaining portions of the system 100.

The housing 130 preferably partially encloses a sampling volume 131 defined between the CCP 110 and the light source 120, thereby defining the sampling volume 131. The sampling volume 131 can have various shapes, such as: a straight channel, a tapered channel, a cylindrical volume having one open end, and any other suitable volumetric shape. The sampling volume can be a virtual volume (e.g., substantially open, defined arbitrarily in space, etc.), a physical volume (e.g., substantially enclosed by impermeable surfaces), and any other suitable volume.

The one or more orifices 132 function to allow particles into the sampling volume 131 from outside the housing 1300. In variations, the housing can define a single orifice 132; however, in alternative variations, the housing can define a plurality of orifices 132 (e.g., in a lattice configuration, a through-hole configuration, a mesh configuration, etc.). In some variations, the housing 130 can retain the CCP and/or light source in an open configuration, wherein the housing 130 omits an orifice 132.

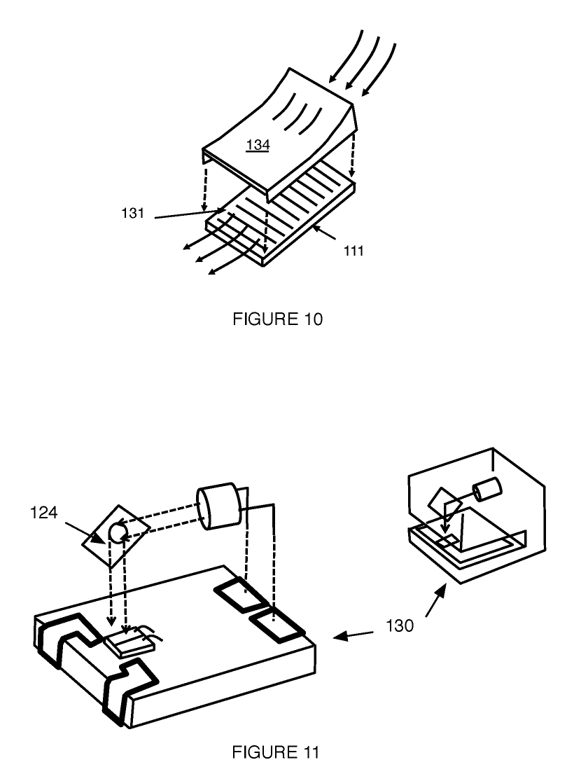

The flow guide 134 functions to passively direct fluid (e.g., particle laden fluid) into the sampling volume 131. The flow guide 134 can, in examples, include a transparent light pipe louver (TLPL) structure (e.g., shown by example in FIG. 10). The TLPL structure can be arranged between the CCP array (e.g., a linear array) and be oriented relative to fluid flow proximal the array such that a funnel effect is induced between inlet and outlet fluid flow that pushes particles towards and/or across the array detector surface (e.g., to generate a tone burst differential output signal). However, the TLPL structure can be otherwise suitably arranged. The flow guide 134 can additionally or alternatively include vanes, channels, and any other suitable morphological features for guiding the flow within and/or proximal the housing 130.

As shown in FIG. 11, a specific example of the housing 130 can include using a surface mount 0603 device (SMD) package to retain and relatively arrange portions of the system 100. For example, the CCP can be approximately 175 microns×175 microns in size and can be epoxy fixated to a ceramic substrate of the housing 130 with dimensions of 1.6 mm by 0.8 mm patterned with four solder-reflow contact points around each corner. Wire bonds can be used interconnect the CCP to the ceramic base. A 90-degree reflector (e.g., optic 124 of the light source) can be arranged superior to (e.g., above) the CCP and can reflect probe light) emitted by the light source (e.g., an LED, VSCEL or similar light emitter of the light source) onto the detection surfaces of the CCP. The housing in this example an include a protective shell, which can be fitted over the ceramic subassembly. The housing in this example can include an orifice configured as a window slot in the shell, which can function to allow particles to enter and be detected.

### 3.4 Actuator

The system 100 can include an actuator 1400. The actuator 140 functions to actuate portions of the system 100. The actuator 140 can also function to actively transport fluid (e.g., particle laden fluid) and/or particles into the sampling volume 131 defined by the housing 130. The actuator 140 can also function to inject phase content into the input signal by way of the structure of the CCP (e.g., instead of via modulation of the light source); this can, in variations, be used to modulate an input signal resulting from a passive source (e.g., a scattering object reflecting sunlight or interior room lights). Actuation can include vibration (e.g., dithering), rotation, slewing, and any other suitable motion.

In variations of the CCP 110 including a vernier-line or similar separation offset, usage of the CCP can include inducing a dithering motion of the detector along one axis (e.g., using a piezoelectric drive, stationary electro-drive birefringent optics, etc.) using the actuator 140 (e.g., to increase signal-to-noise performance of the CCP). This motion is preferably perpendicular to the vernier-line direction and injects polarity coding (e.g., bipolar coding, polarity modulation) into the detected signal, wherein the modulated signal has phase content proportional to the phase content of the motion. With this embedded +1 and −1 coding signal interweaved into the particle signal, synchronous lock-in signal extraction techniques can be used to sense low-intensity and/or noisy signals via phase-sensitive detection.

In further variations, the actuator 140 can include an enclosure or sub module, such as an acoustic driver, that is coupled, either directly or indirectly, to the housing. The acoustic driver can utilize a speaker diaphragm, electromagnetic drive, piezo element, or reciprocating element for a pumping action, to push air through or past the CCP at known flow rates. In a specific example, the actuator 140 includes a diaphragm pump (e.g., an acoustic diaphragm pump, an acoustic driver, etc.) coupled to the housing (e.g., via a ported connection), which is operable to drive fluid flow through and/or within the sampling volume defined between the light source 120 and the CCP 110.

In another variation, an example of which is shown in FIG. 20, the actuator 140 can include a dither mirror that alternately directs an optical input signal between a first detector and a second detector of the CCP. The dithering action of the mirror preferably generates a bipolar differential output signal that contains phase content substantially equivalent to the phase content injected via the dithering action of the dither mirror.

In further variations, the actuator 140 can include a thermal actuator. For example, the actuator 140 can include a heating element (e.g., a resistor) arranged at one side of a CCP (or end of a CCP array), wherein activation of the heating element establishes a thermal gradient across the CCP and fluid (e.g., particle laden fluid) proximal the CCP to drive flow across the CCP (e.g., substantially perpendicular to a vernier line defined between the first and second detectors of the CCP).

In still further variations, the actuator 140 can include one or more flow structures that function as passive control surfaces for fluid flow proximal the system 100. For example, the actuator 140 can include one or more turbulators (e.g., dimples, protrusions, ridges, channels, etc.) arranged proximal to the CCP (e.g., adjacent to the CCP, formed as part of the housing, formed as part of an internal component of the housing, etc.) that turbulate fluid flowing proximal the CCP to increase particle transport toward the CCP (e.g., through a boundary layer above the CCP) and thereby increase a probability of particle detection events. In another example, the actuator can include one or more flow channels (e.g., parallel flow channels, channels in a bullseye configuration, etc.) arranged proximal the CCP to guide flow in any suitable manner relative to the CCP detection surfaces (e.g., to increase relative flow rate of cross flow a region proximal the CCP relative to regions distal the CCP). However, the actuator 140 can additionally or alternatively include any suitable passive and/or active flow controls surfaces.

### 3.5 Processor

The system can include a processor 150. The processor 150 functions to process the outputs (e.g., collective output, differential outputs, etc.) produced by one or more CCPs and/or CCP arrays as described above. The processor 150 can also function to implement, in whole or in part, the method 200 described in Section 4 below. Processing the outputs can include performing various analog domain and/or digital domain computations, such as: summing, subtracting, dividing, multiplying, Boolean operations, ternary or trinary logic operations, multi-value logical operations, and any other suitable operations. The processor 150 preferably includes signal processing circuitry 152 and a computing mechanism (e.g., a central processing unit) 154, but can additionally or alternatively include either circuitry 152 or a computing mechanism 154 having substantially equivalent functionality, and/or any other suitable processing components.

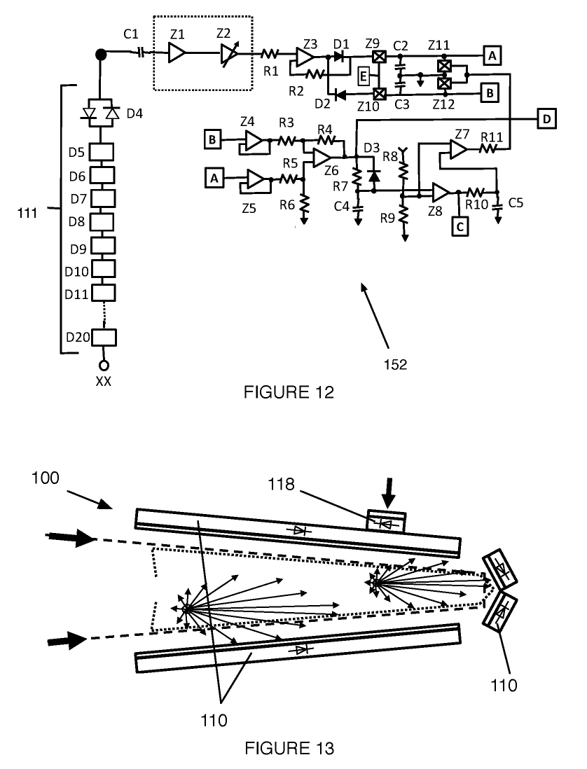

The processor 150 can include signal processing circuitry 152, an example of which is shown in FIG. 12. The signal processing circuitry (e.g., circuitry) 152 functions to perform on-chip computation downstream of the CCP (e.g., subsequent to computation in the analog optoelectronic domain). The form factor of the electronics can, in variations, permit an SMD package size for the system 100 (E.g., that can be inclusive of circuitry 152). In this example, a CCP array with multiple elements (D4, D5, D6, D7, D8, D9, D10, D11, and up to D20) can be equated to a cascaded string of voltage sources (e.g., signal voltage sources). In the null state (e.g., zero-voltage output across the sense and reference nodes), all sources (D4 to D20) are at zero volts and therefore, the summed voltage at the sense node 115 referenced to the reference node 116 at (D20) is also substantially equal to zero volts. As a perturbation to the input illumination tracks across the CCP array (e.g., due to a particle), a series of bipolar zero-cross differential outputs of characteristic peak-to-peak amplitudes are generated at each vernier line of each of the linear CCP array CCPs, with substantially equal periods. producing a tone burst (e.g., periodic signal persisting for a finite period of time, a quasi-periodic signal, etc.). This tone burst can, in variations, be DC or AC coupled into the signaling circuitry 152. DC coupling is preferably used when background AC+DC levels are desired. AC coupling is preferably used when pulse tones signals are desired. However, AC and/or DC coupling can be used in any combination in alternative variations for any suitable purpose.

An example circuit 152 and the connectivity of blocks thereof is depicted in FIG. 12. The pulse signals thus generated (e.g., the tone burst) can be AC coupled through C1, and subsequently enter a preamplifier block with buffer and amplifier op-amps Z1 and Z2, respectively, as shown in FIG. 12. The amplified AC signal is the series of pulses from (D4 to D20) making up the tone burst. This signal can then be input into a bipolar peak-to-peak hold detector including input R1, feedback R2, blocking diodes D₁ and D2, hold capacitors C2 and C3, and Sample Hold Switches Z9 and Z10. The peak-to-peak tone burst value can then be captured by C2 and C3 and fed to outputs of the network, until it is reset via switches Z11 and Z12. This signal can then enter into a circuit block at inputs (A) and (B) to an instrument amplifier circuit including buffers Z4, Z5 and instrument amplifier components R3, R4, R5, R6 and amplifier Z6. The instrument amplifier can transform the peak-to-peak signal into a ground referenced DC signal at the output of Z6.

The DC signal gate Z6 can enter an RC circuit consisting of R7, C4 and fast discharge diode D3. The voltage on C4 can increase from ground up to the maximum peak level at output of Z6. This RC signal can then enter a circuit block wherein a threshold comparator Z8 compares this signal with a trip point value (e.g., trigger value, threshold value), which can be determined by the voltage bridge of R8 and R9. Once Z8 triggers, the output C can send an interrupt signal to a microprocessor of the processor to read the DC peak value stored at output of Z6 connected to output D. Read time (e.g., a hold period for the value to be read) can be offered by delay components R10 and C5, but additionally or alternatively a reset signal can be applied at the output of Z7 that can discharge the peak-to-peak signal storage capacitors C2 and C3. In this example implementation, this signal processing cycle can for every input signal signature sensed that exceeds the minimum level determined by the reference bridge R8 and R9.

The processor 150 can include a computing mechanism 154. The computing mechanism 154 functions to perform computations in the digital and/or software (e.g., pure software, firmware, etc.) domain. The computing mechanism 154 can also function to implement Blocks of the method 200, substantially as described below in section 4. However, the computing mechanism 154 can additionally or alternatively perform any other suitable function.

Using the aforementioned example signaling circuit 152 and/or any other suitable signaling circuit 152, the computing mechanism 154 of the processor 150 can be alerted of detected particles wherein the particle parameter triggers an action (e.g., exceeds a threshold value, matches a reference pattern, etc.). Similarly, analog and digital circuitry can be patterned into a chip (e.g., the same chip in which the CCP is fabricated in examples) to form a fixed circuitry implementation (e.g., state machine) to relieve processing clock cycle burden on the computing mechanism 154 (e.g., supporting microprocessor). This can, in examples, function to prolong battery life in a portable or other low-power use case or application of the system 100 (e.g., in an application wherein the system 100 is integrated into a mobile device, into an in-home smoke detector, into a vehicle system as an in-vehicle air quality monitor, etc.).

### 3. System Specific Examples

In a first specific example, the system includes a current confining pixel (CCP), a light source, and a housing. The CCP includes a first photodiode having a first polarity and defining a first detection surface, a second photodiode electrically connected to the first photodiode at a first conductive pathway and a second conductive pathway, the second photodiode having a second polarity opposing the first polarity and defining a second detection surface, a sense node electrically coupled to the first conductive pathway, and a reference node electrically coupled to the second conductive pathway. The light source defines an illumination region that intersects at least one of the first surface and the second surface, and is arranged distal the first and second photodiode to define a sampling volume. The housing retains the CCP and the light source, wherein the housing partially encloses the sampling volume.

In a related example, the system further includes a bias element coupled to the CCP and retained within the housing. The bias element is operable between a plurality of modes, including a compensation mode. In the compensation mode, the bias element biases at least one of the first photodiode and the second photodiode to produce a voltage difference across the sense node and the reference node (e.g., a voltage difference substantially equal to zero, a voltage difference equal to a set point, etc.).

In another related example, the first detection surface and the second detection surface cooperatively form a channel defining a first end and a second end. In this case, the sampling volume is at least partially defined by the channel, along which the first detection surface opposes the second detection surface (e.g., the first and second detection surfaces face one another).

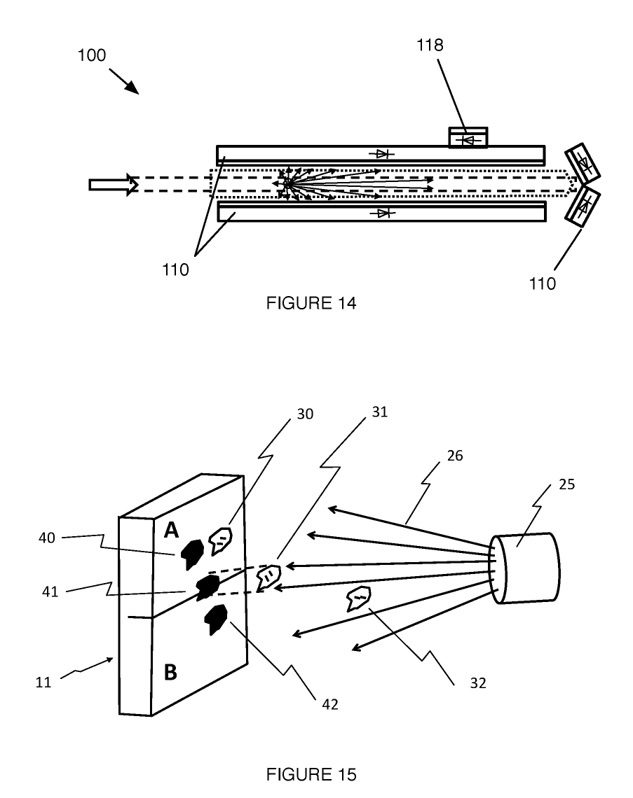

In specific examples, as shown in FIGS. 13-14, the system 100 can be used to detect simultaneously far-field, boundary layer, and near-field particle interaction properties with a light source. FIG. 13 depicts a configuration that is preferably used in cases including a non-laser type (e.g., LED) light source, while FIG. 14 depicts a configuration that is preferably used in cases including laser probe light as the light source. For both example configurations, the system 100 includes two CCPs arranged in a top and bottom symmetrical layout wherein the active areas (e.g., detection surfaces) of each facing opposing directions. This arrangement forms one side of the optical balance beam while a third detector forms the other side with an active area that is not viewing the sensing zone, but is arranged to sense a bias illumination from a controlled source. The circuit diagram shows the electrical circuit including the output sense node and reference node of this balance. A second detector-pair is arranged as an obtuse angle differential detector circuit that forms a second optical balance that is positioned with the active areas intercepting the probe light beam. In operation, probe light from an LED source or equivalent light source is focused into the sampling volume. Without particle presence, the background light (e.g., “glow”) from the probe light beam is fully cancelled by the bias illumination, as detectable at the differential output (e.g., at the sense nodes and reference node). The second balance is for direct-detection where the detectors of the CCP and are aligned to sense the probe light beam at its centroid point. This preferably results in a differential output signal near zero-null (e.g., logical zero), at the second balance sense node, without particle presence. In related examples, a biasing element can be coupled to the second balance to permit automatic gain control and to maintain a mean-signal of zero at this sense node. With particle presence, flow is driven by diffusion or active airflow that enters the sampling volume from the open areas not occupied by the CCPs. Particles within the probe light zone can then result in light scattering that is detected by the parallel portions of the CCPs, while particles entering the direct detection zone have a high probability of dwelling within the V-channel of the base CCP. Thus, this example configuration enables extraction of boundary layer and near-field particle properties that adds to Mie scattering signals to yield particle-typing signatures with time-dependent flow patterns that can enhance particle-detection value in many applications.

The laser-based example configuration shown in FIG. 14 is similar to the configuration described, with the exception that a laser source is employed. Due to the narrow collimated beam, the detector arrangement can be parallel and close together in comparison to the LED-based configuration. The sampling volume in this example is now a parallel narrow channel permitting large solid-angles of view (e.g., compared to the V-shaped channel) to particles interacting with the laser light, which can improve the signal-to-noise ratio. For the CCP performing direct-detection, higher optical power enabled by the laser light source also increases SNR where the noise limit is from shot noise.

In another related example, the system 100 includes an actuator coupled to the housing. The actuator in this example is operable between a plurality of modes including a flow mode. In the flow mode, the actuator drives fluid through the sampling volume. The actuator in this example can include an acoustic diaphragm pump, and/or any other suitable actuator.

### 4. Method

As shown in FIG. 2, an embodiment of the method 200 for particle detection and characterization includes: detecting, at a CCP, an optical signal S210; generating, at the CCP, a bipolar differential signal based on the optical signal S220; and extracting, at a processor communicatively coupled to the CCP, a particle parameter S230. The method 200 can optionally include: compensating the CCP S204; modulating the optical signal S206; and, producing an output based on the particle parameter S240.

### 4.1 Compensating

The method 200 can optionally include Block S204, which includes: compensating the CCP. Block S204 functions to actively bias one or more detectors of the CCP. Block S204 can also function to set a zero-null point of the CCP. Block S204 can also function to zero out a differential output signal of a CCP.

Block S204 is preferably performed by a biasing element substantially similar to the biasing element 118 as described above in Section 3, but can additionally or alternatively be performed by any suitable component. In variations, Block S204 can be performed by a light source (e.g., substantially as described above) wherein compensating the CCP includes optically compensating the CCP.

In a first variation, Block S204 includes providing a bias illumination. The bias illumination can be provided at a detection surface of a single detector (e.g., to provide an optical weight to one side of the CCP balance), at a backside of a single detector, at a detection surface or backside of both detectors of a CCP (e.g., to increase the overall input signal intensity without creating a differential output signal), and/or otherwise suitably provided. The bias illumination is preferably provided using a dedicated bias illumination light source (e.g., distinct from the probe light source that generates the input signal), but can additionally or alternatively be provided by a single light source (e.g., the probe light source that generates the input signal) and/or any suitable light source.

In a second variation, Block S204 includes providing a bias voltage. The bias voltage can be applied to a single detector of a detector pair (e.g., to adjust the zero null point, the CCP balance point, etc.), both detectors of a detector pair (e.g., to offset differential output signal by the bias voltage), and/or otherwise suitably applied. The bias voltage is preferably provided by an ungrounded voltage source (e.g., a battery, a plurality of batteries, a ballast capacitor, etc.) such that the CCP can remain floating; however, the bias voltage can additionally or alternatively be provided by any suitable grounded or ungrounded voltage source (e.g., an AC-DC converter, a mains-connected electrical power source, etc.).

In another variation, Block S204 includes compensating a CCP array. The CCP array can be uniformly compensated (e.g., wherein each CCP is compensated by the same amount) or non-uniformly compensated (e.g., wherein each CCP is compensated by a differing amount, wherein a subset of CCPs is compensated by a first amount and a second subset is compensated by a second amount, etc.). However, Block S204 can include otherwise suitably compensating a CCP array.

### 4.2 Modulating

The method 200 can optionally include Block S206, which includes: modulating the optical signal. Block S206 functions to inject phase content into the optical signal, either as generated (e.g., by modulating the light source) and/or as received (e.g., by modulating the CCP itself). Block S206 can also function to improve an SNR of the differential output signal (e.g., generated in accordance with Block S220) by enabling phase-sensitive detection.

In a first example, Block S206 includes modulating the CCP in order to inject phase content into the signal received at the CCP. Modulating the CCP can include vibrating the CCP (e.g., with a piezoelectric stage), rotating the CCP (e.g., using a rotation stage), and/or otherwise spatially or temporally modulating the CCP. Modulating the CCP can include adjusting the effective detection area of the CCP and/or components thereof; for example, in a CCP having segmented detector surfaces, spatially modulating the CCP can include adjusting the connectivity of the segments as a function of time and thereby adjusting the extent and/or orientation of the detector(s) of the CCP as a function of time. However, spatial modulation of the CCP can be otherwise suitably achieved.

In a second example, Block S206 includes modulating the input signal (e.g., the optical signal) prior to detection. Modulating the input signal can include cycling the input signal (e.g., according to a symmetric duty cycle, an asymmetric duty cycle, a variable duty cycle, etc.), acoustically modulating the input signal (e.g., using an AOM), electro-optically modulating the input signal (e.g., using an EOM), deflecting the input signal (e.g., via an AOM, EOM, etc.), phase-rotating the input signal (e.g., using a polarizer or polarization filter), and otherwise suitable modulating the input signal.

### 4.3 Detecting

Block S210 includes: detecting, at a CCP, an optical signal. The optical signal is preferably received at a CCP, but can additionally or alternatively be received at a plurality of CCPs (e.g., a CCP array) or at any other suitable detector. Block S210 functions to convert the optical signal into the optoelectronic domain within the CCP (e.g., by converting one or more photons in the optical signal to electron-hole pairs in the semiconductor material of the CCP). Block S210 can also function to confine photocurrent generated by the detector pair of the CCP in the loop formed by the stable inverted-polarity node configuration. Block S210 is preferably performed using a CCP and/or CCP array substantially as described above in Section 3; however, Block S210 can additionally or alternatively be performed using any suitable component or detector.

In relation to Block S210, the optical signal can be a single-valued signal (e.g., the intensity of a single probe beam), a multi-valued signal (e.g., the two-dimensional distribution of intensity in an image, an intensity distribution of an incident illuminating beam), a multi-spectral signal (e.g., containing wavelength components from disparate portions of the electromagnetic spectrum, ranging from far IR to far UV, etc.), a time-varying signal, a spatially-varying signal, and any other suitable optical signal.

In relation to Block S210, the optical signal can be detected simultaneously at a plurality of CCPs. For example, the optical signal can include a two-dimensional signal (e.g., an image), and portions of the image can be simultaneously detected at each CCP in a 2D array (e.g., analogously to CCD pixels at the imaging plane of a camera system). The optical signal can additionally or alternatively be detected sequentially. The optical signal can be detected sequentially at a CCP array; for example, a particle can traverse a linear array of CCPs in sequence to produce a tone burst signal at the output of the CCP array. However, the optical signal can additionally or alternatively be otherwise suitably detected at a plurality of CCPs.

### 4.4 Generating a Differential Signal

Block S220 includes: generating, at the CCP, a bipolar differential signal based on the optical signal. Block S220 functions to convert the detected single ended signal (e.g., in Block S210) into a differential output signal that includes a zero-crossing and is thus bipolar, and can be symmetrically bipolar. Block S220 is preferably performed at a CCP substantially as described above in Section 3, but can additionally or alternatively be performed at any suitable balanced and/or differential detector. Accordingly, the differential output signal is preferably generated between a sense node and a reference node of a CCP as described. In variations, the differential output signal can be generated between a sense node of a first CCP and a reference node of a second CCP, wherein the first and second CCPs are connected in a CCP array (e.g., serially connected, connected in parallel, connected in a lattice network, etc.).

In relation to Block S220, the bipolar differential output signal is preferably proportional to a difference in magnitude between the portion of the optical signal received at a first detector of the CCP and the portion of the optical signal received at a second detector of the CCP (e.g., wherein the first and second detectors are connected in an inverse polarity configuration as described above in Section 3). While the differential output signal is preferably proportional to a difference in intensity magnitudes, the magnitude of the intensity of the signal at each detector can, in variations, be proportional to various other signal differences (e.g., wavelength, phase, polarization, angle of incidence, etc.); therefore, the differential output signal can be proportional to a difference in these other aforementioned properties and any other suitable properties that can be converted into a perceived intensity variation between the detectors of the CCP.

In relation to Block S220, generating the differential output signal can be performed at a CCP operating in the photovoltaic (PV) or photoconductive (PC) modes. In the photovoltaic mode, each of the detectors of the CCP is preferably unbiased, and generates a current in response to photons received in the bandgap of the detector. In the photoconductive mode, each of the detectors of the CCP is preferably reverse biased, and generates a current in response to received photons within the increased (e.g., by the reverse bias) depletion junction. Though the PC mode can result in increased dark current, the dark current is preferably confined in the CCP loop as in other configurations, thereby minimizing observed dark-current noise across the sense node and reference node of the CCP. In either the PV or PC modes, Block S220 preferably includes confining the fraction of the current that corresponds to symmetric illumination of the inversely-connected detectors within the CCP loop. In some variations, Block S220 can include generating the differential outputs at CCPs that operate in either the PC or PV mode, simultaneously (e.g., wherein one detector is reverse biased into the PC mode and the other detector is in the PV mode, wherein a first CCP of a CCP array is operated in the PC mode and a second CCP of the CCP array is operated in the PV mode, etc.) and/or sequentially (e.g., in the PC mode for a first time interval, followed by the PV mode for a second time interval).

A specific example implementation of Block S220 is depicted in FIG. 15. As shown, a single-element or dual-element light source (25), with light rays (26) can be directly beamed at the detector block (11) made up of the dual photodetector, A/B pair. Illustrated here is a particle flowing across the detector block (11) and progressing from position (30) to (31) to (32). As the particle crosses the boundary region (16) of the detector block (11) surface, three optical events can be observed (e.g., discernible in a differential output signal). The first can include the creation of successive shadows (40, 41, 42) on the detector surface, as the particle moves from respective positions (30, 31, 32) while passing through the boundary region (16), and attenuates the incident light intensity rays (26) to that detector. The second can include the diffraction effect that creates darker and lighter intensity rings around the perimeter of the shadow. The third can include other scattering effects (e.g., such as from the particle's properties including reflectance, translucency, etc.) that can alter the direction of light (e.g., refract the light) passing the particle prior to reaching the detector. In all, the combined disruption from shadowing, diffraction and other scattering preferably forms an event-driven signature signal pattern that flips in polarity (e.g., instantaneously flips) as the centroid point of the signature pattern crosses the boundary region (11). This forced-symmetry converts such particle signals into symmetric AC signals where the pulse width, rise-fall times and peak-to-peak variations encode (e.g., encapsulate, describe, etc.) particle attributes for size, density and flow dynamics, and other suitable particle properties described by particle parameters. It can also permit the use of phase-lock techniques to sense and integrate submicron particle signals (e.g., weak signals).

### 4.5 Extracting a Particle Parameter

Block S230 includes: extracting, at a processor communicatively coupled to the CCP, a particle parameter. Block S230 functions to interpret the differential output signal (e.g., as generated in accordance with Block S220) in order to determine the characteristic(s) of the particle(s) that resulted in the differential output signal. Block S230 is preferably performed by a processor substantially as described above in Section 3 (e.g., by one or both of a signal processing circuit and a computing mechanism), but can additionally or alternatively be performed by any suitable device capable of signal processing (e.g., a remote server, a mobile device, etc.).

In relation to Block S230, the particle parameter can include any one or more of: a particle size, a particle shape, a particle composition, a particle velocity, a particle refractive index, a particle permittivity, a size distribution of a plurality of particles, a shape distribution of a plurality of particles, a composition of a plurality of particles, a velocity distribution of a plurality of particles, a bulk refractive index of a plurality of particles, a bulk permittivity of a plurality of particles, and any other suitable characteristic or property of one or more particles.

In a variation, Block S230 can include detecting phase content in the differential signal. The detected phase content can be injected (e.g., as in Block S206) or present in the input signal naturally (e.g., without active modulation). In cases wherein the phase content is injected into the optical signal, Block S230 can include demodulating the differential output signal using the monitored phase content during injection, to remove common mode noise via lock-in phase-sensitive detection techniques. In some examples, phase content can include a resonance, and Block S230 can include detecting the resonance. In these examples and other related examples, Block S230 can include detecting the resonance based on a logical output of the CCP (e.g., wherein the output of the CCP is equal to logical zero when the input signal is resonant, and not equal to logical zero when the input signal is not resonant).

In an example, this variation of Block S230 can include extracting particle characteristics based on the output; in particular, in a specific example, Block S230 can include extracting properties of multiple particles using a CCP detector pair, within the analog optoelectronic domain, and generating output signals at a sense node (e.g., with or without downstream processing electronics). The output signal waveforms generated at the sense node can classify particles and/or encode particle properties based on any one or combination of rise/fall times, positive/negative signal peaks, positive/negative slope inflections, long/short duty cycles and on/off cycles, symmetry attributes, and other suitable signal features.

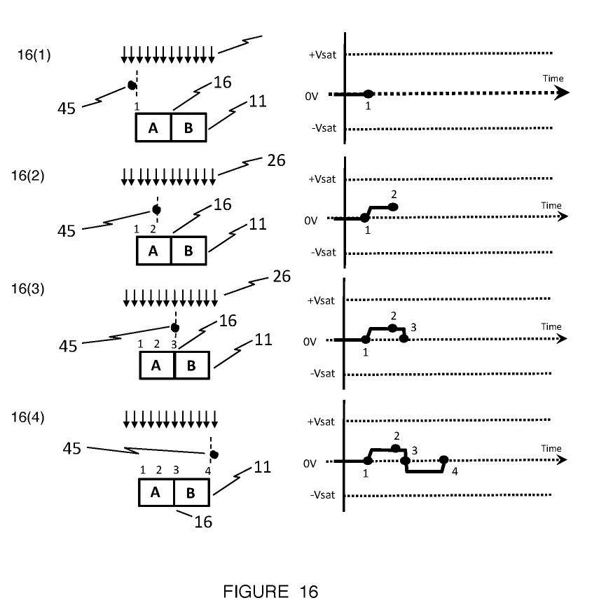

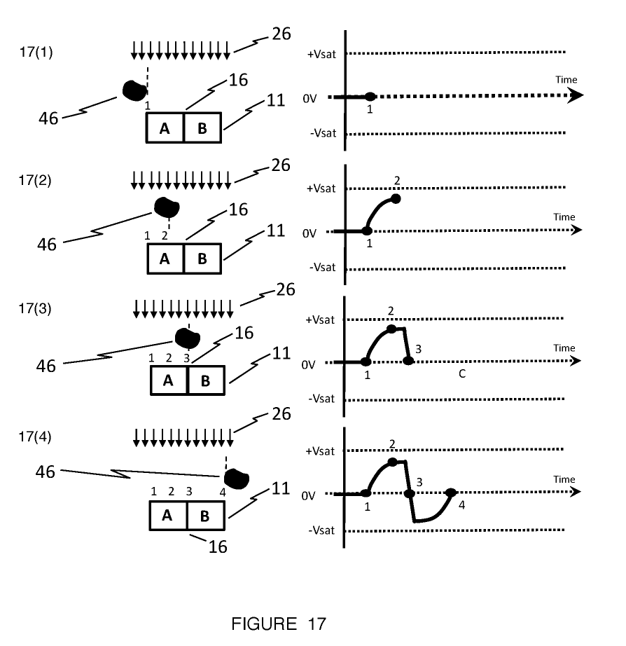

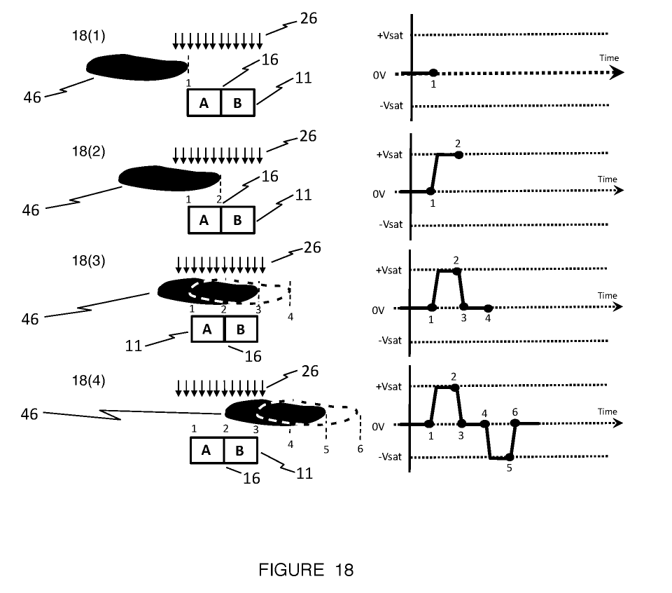

As described above, the inherent bipolarity of the signals resulting from the crossing of particle across the first and second detector of a CCP (depicted by way of example in FIGS. 16-18) enables extraction of particle parameters from the bipolar differential output signals. FIGS. 16-18 depict an example sequence of events for several particle sizes, FIG. 16 showing the situation when a small particle (45) crosses the boundary region (16), FIG. 17 showing the situation when a medium sized particle (46) crosses the boundary region (16), and FIG. 18 showing the situation when a large sized particle (47) crosses the boundary region (16). Implementation of a specific example of Block S230 can include determining the particle sizes based on the resulting bipolar differential output signals described in the following. In each Figure there is shown light rays (26) beamed at the dual detector pair, A/B, of the detector block (11) (e.g., the CCP). For all situations described below, the dual detector pair semiconductor is N-type for active area A, and P-type for active area B. In related examples, wherein the polarity is reversed, the sense node (23) signal also reverses in polarity, into a complement signal. The left side of each of FIGS. 16, 17, and 18 shows the location of the particle over the detector block at positions 1, 2, 3, 4 or 5. The right side of each of FIGS. 16, 17, and 18 shows a graph of the bipolar differential output signal emanating from the detector block (11) at the various positions of the particle.

In the top section, 16(1), of FIG. 16, the small particle (45) is located at position 1, just before crossing into a position over detector block (11). The electrical signal from the detector block, with no particle over it, is set at zero volts, and is shown in the graph to the right of top section, 16(1).

In FIG. 16(2), the particle (45) has moved to position 2, over detector area A (the N-active area) of detector block (11). The presence of this particle (45) alters both the intensity (26) and light pattern falling onto detection area A due to effects of shadowing and/or light scattering (e.g., Rayleigh, Mie, etc.). The resulting signal change at the detector-pair sense node (23), as referenced to node (24), is shown on the right graph as a fast rise-time increase from point 1 to point 2, toward a more positive open-circuit voltage, because the light intensity sensed by detector area B (P-active area) is now higher than that sensed by detector area A.

In FIG. 16(3), the particle (45) has moved to position 3, where the particle's obscuring shadow centroid is over the boundary line (16). At this moment, the attenuation and diffraction effects on the incident light (26) is equally falling onto detector area A and area B of the detector block (11). This balance condition returns the detector-pair sense node (24) voltage back to null, with fast transition time, from point 2 to point 3.

In FIG. 16(4), the particle (45) has moved fully across the B side of detector block (11) to position 4 just beyond detector B. The sense node signal (23) resulting from particle (45), as it travels over detector B, is a mirrored image of that produced over detector A, but with the important difference of a reversal in voltage polarity. This is shown on the right graph as a negative polarity signal from point 3 to point 4 that rapidly return to zero as the particle clears the detector block (11).

For a medium size particle approaching 50% of the detector area A (or B) of detector block (11) shown in the top section, FIG. 17(1), of FIG. 17, the particle (46) is located at position 1, just before crossing into a position over the detector block (11). The electrical signal from the detector block, with no particle over it, is set at zero volts, and is shown in the graph to the right of top section, FIG. 17(1).

In section 17(2), the particle (46) has moved to position 2, over the detector block (11). The presence of this larger particle (46) creates higher attenuation and scattering on the incident light (26). The signal at detector-pair sense node (23), graphed to the right of section 17(2), shows a rise from point 1 to point 2, yielding a higher open-circuit positive voltage peak and slower signal rise-time as compared to that of FIG. 16(2) discussed above. The magnitude of point 2, in section 17(2), is higher because the light intensity sensed by detector area A has further been attenuated compared to FIG. 16(2) from the increased particle size. This larger effective shadow of the particle can also result in softer (e.g., more gradual) signal rise and fall time characteristics.

In FIG. 17(3), the particle (46) has moved to position 3, where the particle's obscuring shadow centroid is precisely over the boundary line (16). At this moment, the attenuation and diffraction effects on the incident light (26) is equally falling onto detector area A and area B of the detector block (11). This balance condition returns the detector-pair sense node (24) voltage again back to null, but with slower transition time, from point 2 to point 3.

In FIG. 17(4), the particle (46) has moved fully across the B side of detector (11) to position 4 just beyond detector B. The sense node waveform signal (23) resulting from particle (46), as it travels over detector B, is a mirrored image of that over detector A with a flip in voltage polarity. This is shown on the right graph of section 17(4), as a slower negative polarity signal from point 3 to point 4 that returns to zero as the particle clears the detector (11).

For a large particle size shown in the top section, 18(1), of FIG. 18, the particle (47) is located at position 1, just before crossing into a position over the detector block (11). The electrical signal from the detector block, with no particle over it, is set at zero volts, and is shown in the graph to the right of top section, 18(1).

In section 18(2), the particle (47) has moved to position 2, over the detector block (11). The presence of this larger particle (47) creates total attenuation that dominates over scattering effects on the incident light (26). The signal at detector-pair sense node (23), graphed to the right of section 18(2), shows a rise from point 1 to point 2 having a saturated open-circuit positive voltage and wide pulse width as compared to the smaller particles discussed above. The magnitude of point 2, in section 18(2), is saturated because the light intensity sensed by detector area A has been eclipsed to zero while detector area B still views the full light intensity (26). This eclipsing event result in wide positive and negative signal pulse widths, having durations equal to the passage time of the particle over detector area A and area B, respectively.

In section 18(3), the particle (47) has moved to position 3 where the particle shadow has eclipsed over the full detector block (11). Both detector areas A and B are now dark resulting in a zero-volts value at the sense node (23). This condition of total eclipse will hold until the particle (47) moves pass position 4 to permit incident light (26) to reach detector area A. The time duration of the total eclipse, from point 3 to point 4, is directly proportional to particle size.

In section 18(4), the particle (47) has moved across detector area A of detector block (11) to position 5, where the left edge is directly in line with boundary line (16). Additional particle motion will start to result in the sense node (23) voltage going negative as particle (47) continues its path beyond the boundary line (16) to position 6 that fully clears detector area B. The resulting waveform at sense node (23) is a square-wave-like signal, formed by points 1, 2, 3, followed by a zero-volts flat region from points 3 to 4, and ending with a negative square-wave-like signal by points 4, 5 and 6.

### 4.6 Producing an Output

The method can include Block S240, which includes: producing an output based on the particle parameter. Block S240 functions to take action based on the extracted particle parameter. For example, Block S240 can include sounding an alarm, sending a message (e.g., a push notification, a text message, etc.), logging a result (e.g., the particle parameter value, a derived value computed based on the particle parameter, etc.). Producing an output based on the particle parameter can include producing the output based on a value of the particle parameter exceeding a threshold (e.g., a threshold particle per unit volume count), based on the particle parameter falling within a category (e.g., a soot particle category, a PM2.5 particle category, etc.), and any other suitable basis.

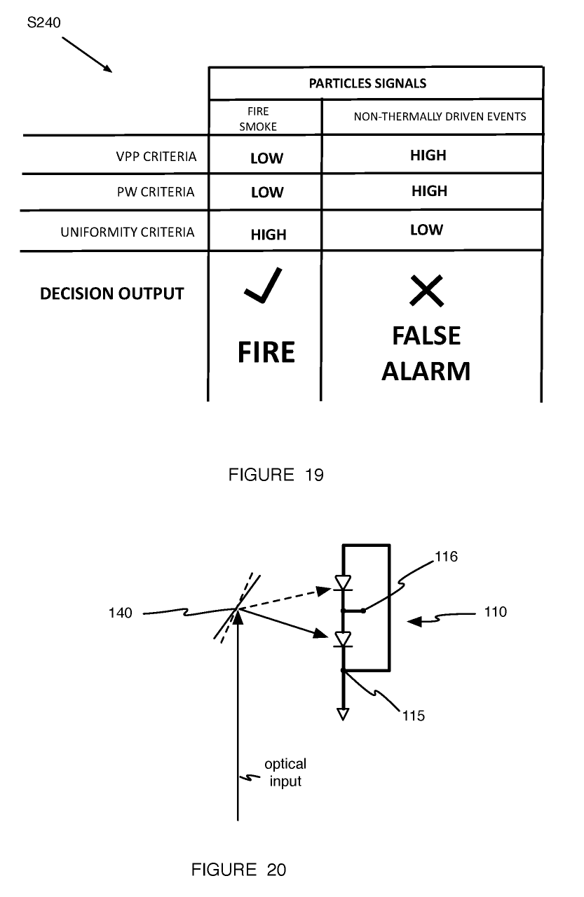

In variations, Block S240 can include producing an output based on a logical operation on the particle parameter. For example, Block S240 can include using a detection algorithm logic table for an advanced smoke detector, an example of which is shown in FIG. 19. Fire plumes at the critical early detection stage often produce particles of combustion dominated in size within the 100-nanometer to 1-micron size range. Contrary to this, dust, steam and other non-fire causes can have a very high concentration of larger particles along with a high degree of non-uniformity mixed in with other airborne particles. The particle detection algorithm table as shown in FIG. 19 can be used, in accordance with Block S240, to reject false alarms by performing tests for three criterions in addition to normal obscuration. Related examples can include testing for other criterions (e.g., timed based profile changes). False alarm rejection criterion 1 may be a HIGH signal reaching both the Vpos and Vneg peak levels. Criterion 2 may be a signal signature with HIGH period or upstretched pulse width. Criterion 3 may be a LOW uniformity in particle size distribution. This qualification process may then assess multiple frames of criterion results, versus time, up to the UL fire detection limits for highest decision reliability before annunciation. In this example, only when all three truths are met, for LOW V peak-to-peak, LOW Pulse Width and HIGH uniformity of signals (in addition to U.L. obscuration level), will a fire alarm be sounded (e.g., an output produced). Particle size distributions that are too small or too large may not meet this criterion (e.g., may not exceed a threshold) and may signify a false alarm or non-fire condition, in this example.

In variations, Block S240 can include triggering an action based on the produced output. The action can include: reading a signal value from a value-holding element (e.g., a charge well, a capacitor, a sample-hold circuit block, etc.), initiating an alarm (e.g., a visual alarm, an aural alarm, a haptic alarm, etc.), transmitting a message, re-compensating one or more CCP set points (e.g., zero null points), and any other suitable action. Triggering based on the output can include triggering in response to an output magnitude exceeding a threshold, based on an integrated output exceeding a threshold (e.g., integrated in a charge well), based on a determined optical center of mass falling within a predetermined region of the detector (e.g., within a predetermined segment of a synthetically rotatable CCP array), based on a ternary logic value output of a CCP and/or CCP array, and any other suitable basis. In a specific example, Block S240 can include triggering an action based on a zero-crossing of the differential output signal.

### 4.7 Method Examples

In a specific example, the method 200 includes: detecting, at a current confining pixel (CCP) substantially as described above in Section 3, an optical signal having an intensity. The intensity is preferably based on a particle parameter (e.g., a distribution of the intensity is based on scattering properties of the particle, the magnitude of the intensity is based on the size of the particle, etc.). In this example, the method 200 also includes: generating, at the CCP in an analog optoelectronic domain, a bipolar differential signal based on the intensity of the optical signal at each of the pair of detectors of the CCP (e.g., the distribution of the intensity between each of the pair of detectors, the symmetry or asymmetry of the intensity, etc.); extracting, at a processor communicatively coupled to the CCP, the particle parameter from the differential signal; and, producing an output based on the particle parameter.

In a related specific example, generating the bipolar differential signal includes: generating a first signal portion having a first polarity corresponding to a first relative intensity of the optical signal between each of the pair of detectors; and, generating a second signal portion, subsequent to generating the first signal portion, having a second polarity corresponding to a second relative intensity of the optical signal between each of the pair of detectors, the second polarity opposite the first polarity.

In another related specific example, detecting the optical signal includes detecting a tone burst signal. Detecting the tone burst signal includes, in this example, detecting, at a linear CCP array that includes a plurality of CCPs, the optical signal (e.g., a periodic time-varying bipolar optical signal resulting from transit of a particle across the successive CCPs of the linear CCP array. In this example, extracting the particle parameter includes extracting a phase content from the tone burst; eliminating a common mode signal from the tone burst based on the phase content to generate a noise-reduced differential signal; and, extracting the particle parameter from the noise-reduced differential signal.

In these and other examples, extracting the particle parameter can include extracting a rise time, a crossing time, and/or a period of the bipolar differential signal.

In another specific example, the particle parameter characterizes a soot particle (e.g., the differential signal output is indicative that a soot particle is within the sampling volume). In this example, producing the output can include triggering an alarm (e.g., a combustion alarm, a fire alarm, a smoke alarm, etc.) based on the indication of a soot particle (e.g., which probabilistically results from a combustion event, a fire, etc.).

However, the method 200 can additionally or alternatively be otherwise specifically implemented in accordance with the above.

An alternative embodiment preferably implements the above methods in a computer-readable medium storing computer-readable instructions. The instructions are preferably executed by computer-executable components preferably integrated with a communication routing system. The communication routing system may include a communication system, routing system and a pricing system. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

Although omitted for conciseness, the preferred embodiments include every combination and permutation of the various system components and the various method processes, wherein the method processes can be performed in any suitable order, sequentially or concurrently, and wherein the system components can be combined in any suitable configuration.

As a person skilled in the art will recognize from the previous detailed description and from the figures and claims, modifications and changes can be made to the preferred embodiments of the invention without departing from the scope of this invention defined in the following claims.

We claim:

1. A particle detection and characterization system comprising:
a current confining pixel (CCP) comprising:
a first photodiode having a first polarity and defining a first detection surface,
a second photodiode electrically connected to the first photodiode at a first conductive pathway and a second conductive pathway, the second photodiode having a second polarity opposing the first polarity and defining a second detection surface,
a sense node electrically coupled to the first conductive pathway, and
a reference node electrically coupled to the second conductive pathway;
a light source defining an illumination region that intersects at least one of the first surface and the second surface, the light source arranged distal the first and second photodiode to define a sampling volume; and
a housing that retains the CCP and the light source, wherein the housing partially encloses the sampling volume.

2. The system of claim 1, further comprising a bias element, coupled to the CCP and retained within the housing, and operable between a plurality of modes comprising a compensation mode, wherein in the compensation mode the bias element biases the at least one of the first photodiode and the second photodiode to produce a voltage difference across the sense node and the reference node.

3. The system of claim 2, wherein the voltage difference produced across the sense node and the reference node in the compensation mode is substantially equal to zero.

4. The system of claim 1, wherein the first detection surface and the second detection surface cooperatively form a channel defining a first end and a second end, wherein the sampling volume is at least partially defined by the channel, and wherein the first detection surface opposes the second detection surface along the channel.

5. The system of claim 4, wherein the channel comprises a tapered channel wherein the second end is narrower than the first end.

6. The system of claim 5, wherein the light source comprises an LED light source.

7. The system of claim 4, wherein the channel comprises a parallel channel wherein the first detection surface and the second detection surface are substantially parallel.

8. The system of claim 7, wherein the light source comprises a laser.

9. The system of claim 4, further comprising a second CCP arranged at the second end of the tapered channel at a terminus of the sampling volume within the illumination region of the light source.

10. The system of claim 1, further comprising an actuator, coupled to the housing, operable between a plurality of modes comprising a flow mode, wherein in the flow mode fluid is driven through the sampling volume by the actuator.

11. The system of claim 10, wherein the actuator comprises an acoustic diaphragm pump.

12. The system of claim 1, further comprising a plurality of CCPs, wherein the plurality of CCPs includes the CCP, the plurality of CCPs arranged in a linear CCP array along a first direction.

13. The system of claim 12, further comprising a transparent light louver arranged between the CCP array and the light source, the transparent light louver configured to direct fluid flow between a first CCP of the plurality of CCPs and a last CPP of the plurality of CCPs along the first direction.

14. A particle detection and characterization system comprising:
a current confining pixel (CCP) comprising:
a first photodiode having a first polarity and defining a first detection surface,
a second photodiode electrically connected to the first photodiode at a first conductive pathway and a second conductive pathway, the second photodiode having a second polarity opposing the first polarity and defining a second detection surface,
a sense node electrically coupled to the first conductive pathway, and
a reference node electrically coupled to the second conductive pathway;
a first light source defining a first illumination region that intersects the first surface, arranged along a direction normal to the first surface, the first light source operable between an on state and an off state;
a second light source defining a second illumination region that intersects the second surface, wherein the first surface is arranged opposite the second surface along the direction, the second light source operable between the on state and the off state; and
a modulator that operates the first and second light sources between a first mode and a second mode, wherein in the first mode the first light source is in the on state and the second light source is in the off state and in the second mode the first light source is in the off state and the second light source is in the on state.

15. A method of particle detection and characterization, comprising:
detecting, at a current confining pixel (CCP) comprising a pair of detectors arranged in an inverse polarity configuration, an optical signal having an intensity, wherein the intensity is based on a particle parameter;
generating, at the CCP in an analog optoelectronic domain, a bipolar differential signal based on the intensity of the optical signal at each of the pair of detectors of the CCP;
extracting, at a processor communicatively coupled to the CCP, the particle parameter from the differential signal;
producing an output based on the particle parameter.

16. The method of claim 15, wherein generating the bipolar differential signal comprises:
generating a first signal portion having a first polarity corresponding to a first relative intensity of the optical signal between each of the pair of detectors; and
generating a second signal portion, subsequent to generating the first signal portion, having a second polarity corresponding to a second relative intensity of the optical signal between each of the pair of detectors, the second polarity opposite the first polarity.

17. The method of claim 15, wherein detecting the optical signal comprises detecting, at a linear CCP array comprising a plurality of CCPs including the CCP, the optical signal, and wherein the bipolar differential signal comprises a tone burst.

18. The method of claim 17, wherein extracting the particle parameter comprises:
extracting a phase content from the tone burst;
eliminating a common mode signal from the tone burst based on the phase content to generate a noise-reduced differential signal; and
extracting the particle parameter from the noise-reduced differential signal.

19. The method of claim 15, wherein the particle parameter comprises a particle size, and wherein extracting the particle parameter comprises extracting a rise time, a crossing time, and a period of the bipolar differential signal.

20. The method of claim 15, wherein the particle parameter characterizes a soot particle, and wherein producing the output comprises triggering an alarm.
